(19) United States
(12) Patent Application Publication
(10) Pub. No.: US 2007/0231724 A1
(43) Pub. Date: Oct. 4, 2007

(54) Image forming apparatus, image forming method and toner

(75) Inventors: Masatoshi Kimura, Kanagawa (JP); Ryuichiro Maeyama, Kanagawa (JP); Takashi Hino, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/604,036

(22) Filed: Nov. 24, 2006

(30) Foreign Application Priority Data
Mar. 28, 2006 (JP) 2006-087839

(51) Int. Cl. G03G 9/09; G03G 9/093

(52) U.S. Cl. 430/108.1; 430/123.5; 430/110.1; 430/110.2; 430/108.23; 430/45.33

(57) ABSTRACT

An image forming apparatus includes an image carrier; an electrostatic latent image forming unit; a developing unit; a color information applying unit; a transfer unit; a fixing unit; and a color forming unit, the toner containing a first component and a second component that are present in an isolated state from each other and that can form the color upon reaction with each other, and a photocurable composition containing at least one of the first component and the second component, the photocurable composition keeping a cured or uncured state by being applied the color.

### BACKGROUND

(1) Technical Field

The present invention relates to an image forming apparatus and an image forming method each employing an electrostatic recording system. In particular, the invention relates to a toner which can be color developed in a different color from each other upon exposure with lights of a different wavelength and an image forming apparatus and an image forming method using the toner.

(2) Related Art

Hitherto, in a recording apparatus for obtaining a color image by an electrophotographic system, basic three primary colors are developed corresponding to respective image information, and the resulting toner images are successively superimposed to obtain a color image. As specific apparatus configurations, there are known a so-called four cycle machine for obtaining a color image by repeating development of one photoreceptor drum having latent images formed thereon by an image forming method for every color and transfer of the developed images onto a transfer member; and a tandem machine for obtaining a color image by providing a photoreceptor drum and a development apparatus for every image forming measure of each color and moving a transfer member to transfer toner images successively and continuously.

These are common at least in the point that a plurality of development apparatus are provided for respective colors. For that reason, in the usual color image formation, four development apparatus are necessary for a black color in addition to the three primary colors, four photoreceptor drums corresponding to each of four development apparatus in a tandem machine are necessary and a measure for adjusting the synchronization of those four image forming apparatus is necessary. Thus, the enlargement of apparatus and an increase of the costs are inevitable.

### SUMMARY

According to an aspect of the invention, there is provided an image forming apparatus including an image carrier; an electrostatic latent image forming unit that applies a charge to a surface of the image carrier to form a latent image; a developing unit that develops the latent image by a developer containing a toner to form a toner image; a color information applying unit that applies the color information by light to the toner image; a transfer unit that transfers the toner image onto a surface of a recording medium; a fixing unit that fixes the toner image transferred onto the surface of the recording medium; and a color forming unit that forms color of the toner image that is applied the color information, the toner containing a first component and a second component that are present in an isolated state from each other and that can form the color upon reaction with each other, and a photocurable composition containing at least one of the first component and the second component, the photocurable composition keeping a cured or uncured state by being applied the color information by light, thereby being controlled a reaction for forming the color.

### BRIEF DESCRIPTION OF THE DRAWINGS

Exemplary embodiments of the invention will be described in detail based on the following figures, wherein:

FIG. 1 is an outline configuration view according to an exemplary embodiment;

FIG. 2 is a schematic cross-sectional view to show a state at the time of applying the color information to a toner image and exposing;

FIG. 3 is a circuit block diagram of a printing controller;

FIG. 4 is an outline configuration view to show an image forming apparatus according to another exemplary embodiment;

FIG. 5A is a schematic view to explain a color development mechanism of a toner, illustrating a color developing part;

FIG. 5B is a schematic view to explain the color development mechanism of a toner, illustrating an enlarged state of the color developing part;

FIG. 6 is a schematic cross-sectional view to show one example of a structure of a toner (the case including a matrix and a photosensitive or thermosensitive capsule as dispersed in the matrix);

FIG. 7 is a schematic cross-sectional view to show another example of a structure of a toner (the case of a concentric circle structure);

FIG. 8 is a schematic cross-sectional view to show another example of a structure of a toner (the case of a stripe structure); and

FIG. 9 is a schematic cross-sectional view to show another example of a structure of a toner (the case of a folding fan structure).

### DETAILED DESCRIPTION

The invention will be hereunder described with reference to the accompanying drawings. Incidentally, the same symbols are given to members having substantially the same function over the whole of drawings, and overlapped explanations thereof may be omitted.

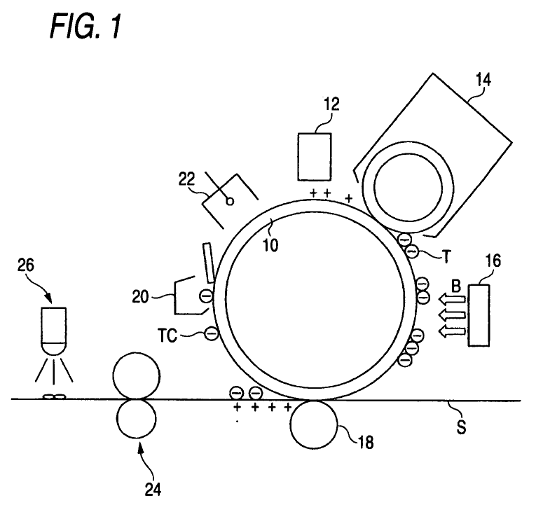

FIG. 1 is an outline configuration view of an image forming apparatus according to an exemplary embodiment.

As illustrated in FIG. 1, the image forming apparatus according to the exemplary embodiment is provided with an image carrier 10, a periphery of which is provided with an electrostatic latent image forming device 12 (electrostatic latent image forming unit) for applying a charge of positive polarity to a surface of the image carrier 10 to form an electrostatic latent image; a developing device 14 (developing unit) for developing the electrostatic latent image by a developing agent containing a negatively charged toner to form a toner image T; a color information applying device 16 (color information applying unit) for applying the color information to the toner image T; a transfer device 18 (transfer unit) for transferring the toner image T onto a surface of a recording medium S; a cleaning device 20 for removing a residual toner TC which remains on the image carrier 10 after the transfer; and a static eliminator for rendering a surface potential of the image carrier 10 after the transfer to a substantially zero potential.

The image forming apparatus according to the present exemplary embodiment is further provided with a fixing device 24 for fixing the toner image T transferred onto the surface of the recording medium S by heat and/or pressure; and a light irradiating device 26 (light irradiating unit) for carrying out light irradiation on the recording medium S for fixing color development of the toner image T, which is located in a downstream side of the fixing device 24. The fixing device 24 also serves as a color developing device (color developing unit) for color developing the toner image T.

For example, when exposed with light having a different wavelength in every particle of the toner, the toner has a function to undergo color development corresponding to the wavelength or to hold a non-color developed state.

In the image forming apparatus according to the present exemplary embodiment, the foregoing toner is used; for example, a charge of positive polarity is applied directly to the image carrier 10 in terms of a logical add of image forming information of four colors of cyan (C) magenta (M), yellow (Y) and black (K) to form an electrostatic latent image (electrostatic latent image forming step); and the latent image is developed with a developing agent containing the toner to form the toner image T (toner image forming step). Next, the toner image T is exposed with light having a wavelength corresponding to the color information to apply color information to the toner image T (color information applying step). The toner image T having the color information applied is then transferred to the recording medium S and fixed (transfer step and fixing step); a color development reaction of the toner is carried out before or after or simultaneously with this by heat (color developing step); and the surface of the recording medium S after the fixation is further irradiated with light to achieve removal or bleaching of a background color (light irradiating step). The residual toner TC which remains on the image carrier 10 after the transfer is then removed (cleaning step); and static elimination is carried out to render a surface potential of the image carrier 10 to a substantially zero potential (static elimination step). There is thus obtained a color image.

Incidentally, in the foregoing exemplary embodiment, a charge of positive polarity is applied directly to the image carrier 10 to form a latent image, followed by developing with a toner charged with negative polarity. However, the invention is not limited to this, but a charge of negative polarity may be applied directly to the image carrier to form a latent image, followed by developing with a toner charged with positive polarity.

The color development mechanism of toner for obtaining a color image by the image forming apparatus according to the foregoing exemplary embodiment will be hereunder described.

First of all, as described later, in applying the color information by light, the toner has one or more continuous regions, named as a color developing part in a binder resin which can be color developed in a specific one color (or can be held in a non-color developed state).

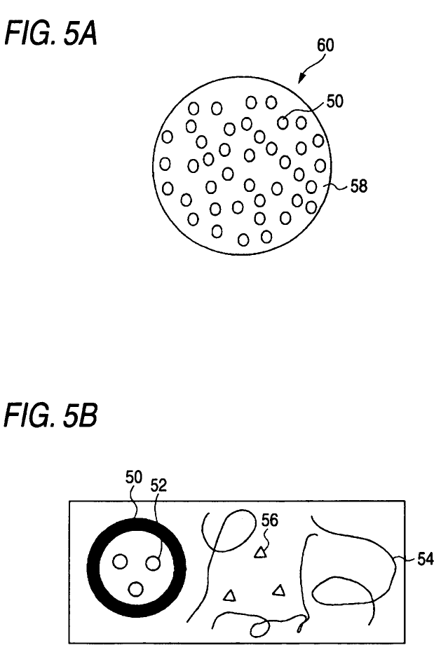

FIGS. 5A and 5B are each a schematic view to show one example of the foregoing color developing part in the toner, in which FIG. 5A shows a cross-sectional view of one color developing part and FIG. 5B shows an enlarged state of the color developing part.

As illustrated in FIG. 5A, a color developing part 60 is configured to have a color developing microcapsule 50 containing a color developing agent of each color and a composition 58 surrounding the color developing microcapsule 50; and as illustrated in FIG. 5B, the composition 58 contains a color former (first component) 52 which is contained in the microcapsule 50, a polymerizable functional group-containing developer monomer (second component) 54 which is color developed upon being made close to or brought into contact with the color former 52, and a photopolymerization initiator 56.

In the color developing part 60 configuring a toner particle, for example, triaryl based leuco compounds having excellent brilliantness of color development hue are suitable as the color agent 52 which is sealed in the color developing microcapsule 50. An electron accepting compound may be used as the developer monomer 54 which colors this (electron donating) leuco compound. In particular, phenol based compounds are general, and can be properly selected among developers which are utilized in thermosensitive or pressure-sensitive papers. The electron donating color former 52 and the electron accepting developer monomer 54 cause an acid-base reaction, whereby the color former undergoes color development.

A spectral sensitizing dye which is sensitized by visible light to generate a polymerizable radical which becomes a trigger for polymerizing the developer monomer 54 is used as the photopolymerization initiator 56. For example, a reaction promoter of the photopolymerization initiator 56 is used such that the developer monomer 54 can advance a sufficient polymerization reaction against the exposure of three primary colors of R color, G color and B color. For example, by using an ion complex made of a spectral sensitizing dye (cation) capable of absorbing exposure light and a boron compound (anion), the spectral sensitizing dye is subjected to photoexcitation by the exposure and causes electron transfer into the boron compound, thereby forming a polymerizable radical and initiating polymerization.

By combining these materials, it is possible to obtain a color developing recording sensitivity of from approximately 0.1 to 0.2 mJ/m² as the photosensitive color developing part 60.

A material containing the developer compound which has been polymerized by the color developing part 60 and the developer monomer 54 which has not been polymerized is present depending upon the presence or absence of light irradiation for the color information against the color developing part 60 of the foregoing configuration. Thereafter, by a color developing device of heating or the like, in the color developing part 60 containing the developer monomer 54 which has not been polymerized, this developer monomer 54 migrates by heat or the like and migrates in and passes through pores of a diaphragm of the color developing microcapsule 50, whereby it is diffused in the color former capsule. In the developer monomer 54 and the color former 52 as diffused in the microcapsule 50, since as described previously, the color former 52 is basic, whereas the developer monomer 54 is acidic, the color former 52 is color developed by the acid-base reaction.

On the other hand, the developer compound which has generated a polymerization reaction cannot diffuse in and pass through pores of a diaphragm of the microcapsule 50 in the subsequent color developing step by heating or the like due to its bulky volume by the polymerization and cannot react with the color former 52 in the color developing microcapsule so that this developer compound cannot undergo color development. Accordingly, the color developing microcapsule 50 remains in a colorless state. That is, the color developing part 60 irradiated with light of a specific wavelength is present without being color developed.

After the color development, by again exposing the entire surface by a white light source at an appropriate stage, not only the residual developer monomer 54 which has not been completely polymerized is entirely polymerized to achieve stable image fixation, but also the residual spectral sensitizing dye is decomposed to achieve decoloration of a ground color. Incidentally, with respect to the spectral sensitizing dye of the photopolymerization initiator 56 corresponding to a visible light region, though its color tone remains as a ground color to the last, a photo-decoloration phenomenon of color/boron compound can be utilized for this decoloration of the spectral sensitizing dye. That is, a polymerizable radical is formed by electron transfer from the photoexcited spectral sensitizing dye into the boron compound. While this radical causes polymerization of the monomer, it reacts with the excited dye radical to cause color decomposition of the dye, resulting in decoloration of the dye.

In the toner according to an aspect of the invention, the color developing part 60 which achieves different color development in such a way (for example, color development in Y color, M color or C color) is configured and used as one microcapsule in such a state that the respective developer monomer 54 does not interfere with other color former than the color former 52 serving as a target (in an isolated state from each other). In this way, a toner containing a microcapsule having the plural color formers 52, each of which achieves different color development, integrated therein is applied in a single developing device to obtain a color image.

By using the toner as described previously, it is possible to obtain a full color image by one image carrier and one developing device. Thus, the size of the image forming apparatus main body becomes unlimitedly close to a size of a monochromic printer so that the apparatus can be miniaturized. In addition to this, since it is not necessary to stack a toner for every color in forming the toner image T, irregularities on the image surface can be controlled, and the gloss of the image surface can be made uniform. Furthermore, since a coloring agent such as pigments is not used in the toner, it is also possible to obtain a silver salt-like image.

Furthermore, in a toner as described later, since a color information applying mechanism against the toner is not a reversible reaction, it is possible to subject a toner which is intended to undergo color development for highlight image formation to color development stably in a density of low or medium tone. Accordingly, it becomes possible to achieve high quality image formation as seen in a current multicolor inkjet printer. Moreover, as described previously, because of the matter that the color information applying mechanism is not a reversible reaction, it has such a merit that there is no temporal restriction until color development by heating. As a result, printing can be achieved even in a low-speed region, namely the toner is adaptable to a wide speed range. In addition, with respect to the arrangement place of a fixing device in which color development is carried out by heating or the like, the toner has such a merit that a degree of freedom is high.

Next, the configuration of the image forming apparatus according to the foregoing exemplary embodiment will be hereunder described along respective steps in the image forming process.

### <Electrostatic Latent Image Forming Step>

The electrostatic latent image forming step is a step for forming an electrostatic latent image by applying a charge of positive polarity directly to the image carrier 10 in terms of a logical add of image forming information of four colors of cyan (C), magenta (M) yellow (Y) and black (K) by the electrostatic latent image forming device 12.

Here, this image carrier 10 may be a dielectric. This dielectric may be, for example, in a belt-like form in which a dielectric is a base material or a dielectric layer is formed on a surface of a base material; or in a drum-like form in which a dielectric layer is formed on a surface of a metallic drum made of aluminum or the like.

Examples of a material which configures this dielectric include polyimides, fluorine resins, polyethylene, polypropylene, ionomers, polyvinyl alcohol, polyvinyl acetate, ethylene/vinyl acetate copolymers, poly-4-methylpenene-1, polymethyl methacrylate, polycarbonates, polystyrene, acrylonitrile/methyl acrylate copolymers, acrylonitrile/butadiene/styrene copolymers, polyethylene terephthalate, polyurethane elastomers, cellulose acetate, cellulose triacetate, cellulose nitrate, cellulose propionate, cellulose acetate butyrate, ethyl cellulose, regenerated cellulose, nylon 6, nylon 66, nylon 11, nylon 12, polysulfones, polyethersulfone, polyvinyl chloride, vinyl chloride/vinyl acetate copolymers, polyvinylidene chloride, vinylidene chloride, vinyl chloride copolymers, vinyl nitrile rubber alloys, polytetrafluoroethylene, polychlorotrifluoroethylene, polyvinyl fluoride, polyvinylidene fluoride, and polyethylene/tetrafluoroethylene copolymers.

On the other hand, for example, an ion writing device (ion writing unit) utilizing an ion may be applied in the electrostatic latent image forming device 12. As this ion writing device, an ion flow control head of a so-called ion flow system which is equipped with an ion generation source (for example, a corona charger) and a pair of slit-provided control electrodes (control slits) can be applied. This ion flow control head controls an ion (a plus ion in this exemplary embodiment) as generated by corona discharge of the ion generation source (for example, a corona charger) with respect to passing or non-passing of the ion flow through the slit depending upon the direction of an electric field between the pair of control electrodes to apply an ion to the selectively and uniformly formed toner, thereby giving a charge.

The ion writing device (ion wiring unit) is not limited to the foregoing, but a microstructure electrode head which is equipped with a pair of indirect electrodes and a control electrode for taking out charges (an electron and an ion) as generated by discharge between the indirect electrodes may also be applied. For example, this microstructure electrode head generates charges (an electron and an ion) by discharge between the pair of indirect electrodes by ON/OFF control of one dot unit by an image signal and takes out the charges by the control electrode, thereby selectively giving the charges to a surface of the image carrier 10. Since this micro-structure electrode head can give a large amount of charges (an electron and an ion) by discharge between the indirect electrodes, the ion flow density is largely improved so that it is useful for realizing high speed of the image forming process.

Furthermore, the electrostatic latent image forming device 12 is not limited to the ion writing device, but a discharge writing device can also be applied. For example, the discharge writing device is configured to have a discharge electrode (for example, a wire electrode or a needle electrode as disposed so as to have a prescribed degree of analysis) which is arranged opposite to the image carrier and a control electrode for controlling discharge from the discharge electrode. In this discharge writing device, a voltage is applied between the discharge electrode and the control electrode to undergo dielectric breakdown of an air layer of a gap between the discharge electrode and the image carrier, thereby applying a charge of the same polarity as the discharge electrode to the image carrier. In particular, it is suitable that the discharge writing device is a device for one-side control in which the discharge electrode and the control electrode are arranged in a side of the image carrier surface.

In such a discharge writing device, as described previously, a charge is generated due to the dielectric breakdown of an air layer of a gap between the discharge electrode and the image carrier, and therefore, it is necessary to keep a space between the discharge electrode and the image carrier. For that reason, a conductive or a semi-conductive elastic material which is provided with a dielectric layer having irregularities for the purpose of keeping the space (for example, media having a volume resistivity of from 10³ to 10⁹ Ω·cm (preferably from 10⁶ to 10⁷ Ω·cm) and containing an elastic material such as carbon-dispersed nitrile/butadiene rubber (NBR)) may be used as the image carrier. Incidentally, the conductive or semi-conductive rubber medium is a material in which a conductive or a semi-conductive rubber layer and a dielectric layer are successively formed on a substrate such as a metallic drum (for example, an aluminum drum).

Here, examples of the dielectric layer having irregularities include a polyethylene resin layer having a volume average particle size of from 2 to 7 μm (preferably from 3 to 5 μm) and blended with a fine particle such as calcium carbonate. It may be suitable that the dielectric layer having irregularities has a surface roughness of from 3 to 15 μm (preferably from 5 to 10 μm).

Incidentally, though the exposure for applying the color information as described later is carried out in a considerably strong intensity (the quantity of energy of light which is provided for applying the color information is required to be about 1,000 times the exposure amount (2 mJ/m²) for forming an electrostatic latent image to be used in a usual electrophotographic process), when a medium in which at least a surface thereof is configured to have a dielectric is applied as the image carrier 10, the image carrier 10 is not deteriorated by the exposure for applying the color information but a color image can be obtained stably and repeatedly over a long period of time.

Furthermore, the foregoing volume average particle size can be determined by the following manner. That is, the volume average particle size is measured by using Coulter Counter TA-II Model (manufactured by Beckman-Coulter Inc.) and ISOTON-II (manufactured by Beckman-Coulter Inc.) as an electrolytic solution.

With respect to the measurement method, a measurement sample is added in an amount of from 0.5 to 50 mg in a surfactant as a dispersant, preferably 2 mL of a 5% aqueous solution of a sodium alkylbenzene sulfonate, and the mixture is added in from 100 to 150 mL of the foregoing electrolytic solution. The electrolytic solution having this measurement sample suspended therein is dispersed for about one minute by an ultrasonic dispersion device, and the particle size distribution of particles having a particle size ranging from 2.0 to 60 μm is measured by using the foregoing Coulter Counter TA-II Model and an aperture having an aperture size of 100 μm. The number of particles to be measured is 50,000.

With respect to the measured particle size distribution, the cumulative distribution is drawn from the small size side regarding the volume and number against the divided particle size range (channel); and a particle size at which the cumulation becomes 16% in terms of volume is defined as a volume average particle size D16ᵥ, and a particle size at which the cumulation becomes 16% in terms of number is defined as a cumulative number particle size D16ₚ. Similarly, a particle size at which the cumulation becomes 50% in terms of volume is defined as a volume average particle size D50ᵥ, and a particle size at which the cumulation becomes 50% in terms of number is defined as a number average particle size D50ₚ. Similarly, a particle size at which the cumulation becomes 84% in terms of volume is defined as a volume average particle size D84ᵥ, and a particle size at which the cumulation becomes 84% in terms of number is defined as a cumulative number particle size D84ₚ. The volume average particle is corresponding to the foregoing D50ᵥ.

Furthermore, the volume resistivity can be determined by the following manner. That is, an electric resistance value is measured by a megger/micro ammeter as manufactured by Advantest Corporation using an HR probe as manufactured by Mitsubishi Petrochemical Co., Ltd. according to JIS K6911 in a measurement circumstance at 23° C. and 55% at an applied voltage of 500 V for 10 seconds, thereby determining a volume inherent resistivity.

Furthermore, the surface roughness can be determined by the following manner. That is, the measurement of the surface roughness is carried out by using a surface roughness analyzer, SURFCOM 1400A (manufactured by Tokyo Seimitsu Co., Ltd.) according to JIS B0601-1994 under a measurement condition of an evaluation length Ln of 4 mm, a standard length L of 0.8 mm and a cut-off value of 0.8 mm.

### <Developing Step>

In the developing step, a latent image is developed with a developing agent containing a toner by the developing device 14 to form the toner image T.

Here, known developing devices can be employed as the developing device 14. All of a two-component developing method using a fine particle for supporting a toner, which is named as a carrier, and a toner; and a one-component developing method using only a toner, including the case where other configuring substances for improving the development and other characteristics are added in these methods can be employed as the developing method.

Furthermore, a method in which the development is carried out in a contact or non-contact state of the developer with the image carrier 10 or in a combined state thereof is employable depending upon the developing method. In addition, a hybrid developing method of a combination of the foregoing one-component developing method and two-component developing method is employable, too. Besides, novel developing measures which will be developed in the future can be employed so far as they achieve the effects according to an aspect of the invention.

Incidentally, with respect to the toner which is used in the developing agent, for example, a single toner particle may contain a color developing part which can be color developed in a Y color (Y color developing part), a color developing part which can be color developed in an M color (M color developing part) and a color developing part which can be color developed in a C color (C color developing part), or respective toners may individually contain the Y color developing part, the M color developing part and the C color developing part.

The developing amount of the toner (the attachment amount of the toner which attaches onto the image carrier) varies depending upon an image to be formed but may be preferably in the range of from 3.5 to 8.0 g/m², and more preferably in the range of from 4.0 to 6.0 g/m² in a solid image.

Furthermore, in the formed toner image T, in order that light for applying the color information as described later extends over the whole of the irradiated portion, it is desired to control the thickness of the toner layer to not more than a certain value. Concretely, for example, the number of the toner layer may be preferably not more than three, and more preferably not more than two in a solid image. Incidentally, the thickness of the toner layer is a value obtained by measuring the thickness of the toner layer as formed on the surface of the actual image carrier 10 and dividing it by the number average particle size of the toner.

### <Color Information Applying Step>

In the color information applying step, the color information by light as shown by arrows B is applied to the toner image T from the color information applying device 16. It is meant by the terms “applying the color information by light” as referred herein that for the purpose of controlling the color developed state or non-color developed state or the color tone in undergoing color development per an individual toner particle unit which configures the toner image T, one or more kinds of light having a specific wavelength are selectively applied to a desired region of the toner imager, or light is not applied at all. Incidentally, the position of the color information applying step may be after the transfer step as described later.

As the color information applying device 16, any device can be used so far as it is possible to irradiate the toner particle which is color developed with light having a wavelength for undergoing color development in a specific color in prescribed resolution and intensity. For example, an LED image bar, a laser ROS, and so on can be used. Incidentally, the irradiation spot size of light which is irradiated on the toner image T may be preferably adjusted in the range of from 10 to 300 μm, and more preferably in the range of from 20 to 200 μm such that the resolution of the formed image is in the range of from 100 to 2,400 dpi.

The wavelength of the light which is provided for the purpose of keeping the color developed or non-color developed state is determined by a material design of the toner to be used. For example, in the case of using a toner which can be color developed upon irradiation with light having a specific wavelength (light color development type toner), light of 405 nm (referred to as “λ_{A} light”) when color developed yellow (Y color), light of 535 nm (referred to as “λ_{B} light”) when color developed magenta (M color) and light of 657 nm (referred to as “λ_{B} light”) when color developed cyan (C color) are irradiated at desired positions to be color developed, respectively.

Furthermore, when color developed in a secondary color, a combination of the foregoing lights is employed. λ_{A} light and λ_{B} light when color developed red (R color), λ_{A} light and λ_{C} light when color developed green (G color) and λ_{B} light and λ_{C} light when color developed blue (B color) are irradiated at desired positions to be color developed, respectively. In addition, when color developed black (K color) which is a tertiary color, the foregoing λ_{A} light, λ_{B} light and λ_{C} light are superimposed and irradiated at a desired position to be color developed.

On the other hand, in the case of a toner which is kept in a non-color developed state upon irradiation with light having a specific wavelength (light non-color development toner), for example, light of 405 nm (λ_{A} light) when intended not to be color developed yellow (Y color), light of 535 nm (λ_{B} light) when intended not to be color developed magenta (M color) and light of 657 nm (λ_{C} light) when intended not to be color developed cyan (C color) are irradiated at desired positions to be color developed, respectively. Accordingly, λ_{B} light and λ_{C} light when color developed in a Y color, λ_{A} light and λ_{C} light when color developed in an M color and λ_{A} light and λ_{B} light when color developed in a C color are irradiated at desired positions to be color developed, respectively.

Furthermore, when color developed in a secondary color, a combination of the foregoing lights is employed. λ_{C} light when color developed red (R color), λ_{B} light when color developed green (G color) and λ_{A} light when color developed blue (B color) are irradiated at desired positions to be color developed, respectively. In addition, when color developed black (K color) which is a tertiary color, a desired position to be color developed is not exposed.

With respect to the light from the color information applying device 16, if desired, known image modulation methods such as pulse duration modulation, intensity modulation, and a combination thereof can be employed. Furthermore, the exposure amount of light may be preferably in the range of from about 0.05 to about 0.8 mJ/m², and more preferably in the range of from about 0.1 to about 0.6 mJ/m². In particular, with respect to this exposure amount, the necessary exposure amount is correlated with the amount of the developed toner. For example, the exposure may be preferably carried out in the range of from about 0.2 to about 0.4 mJ/m² based on about 5.5 g/m² of the development amount of toner (solid).

Incidentally, since the applyation of color information is carried out from only one side of the image carrier 10, the light for causing color development hardly reaches a lower part of the developed toner in a multilayered structure so that sufficient color development is not obtained. As a result, there may be the case where the color taste in the image differs from a desired color taste. Then, in the invention, the image carrier 10 may be provided with a reflection unit for reflecting exposure light which applies color information to the toner image T as formed on the image carrier 10.

For example, the reflection unit for reflecting exposure light can be realized by providing a reflection layer (for example, a substrate of a dielectric layer-provided metallic drum, etc.) in the lower layer of the transparent layer in the image carrier 10. In the case of providing a reflection layer in the lower layer of the dielectric layer, the surface of the reflection layer may suitably have an arithmetic average roughness Ra according to JIS B0601 of not more than 12.5 μm. In the case of providing the reflection unit, the reflectance of the exposure light may be suitably 80% or more, and more suitably 90% or more.

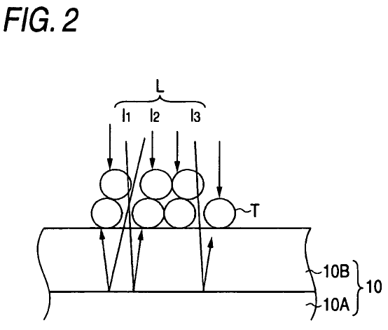

Here, FIG. 2 shows a cross section of the image carrier 10 having a toner image supported thereon at the time of exposure for applying the color information. In FIG. 2, an image carrier in which a transparent dielectric layer 10B is provided as the reflection unit on a substrate 10A of a metallic drum or the like is applied as the image carrier 10. In this way, as illustrated in FIG. 2, in the case where the toner image (toner layer) T as formed on the image carrier 10 is exposed with exposure light for applying the color information (arrows L in the figure), from about 10 to 50% of the light passes through the toner itself or a gap of the toner layer and reaches the image carrier 10. In addition, by transmitting the light through the transparent dielectric layer 10B of the image carrier 10 and reflecting the transmitted light on the substrate 10A as the reflection unit to again expose the toner image T as in l₁ to l₃ in the figure, it is possible to expose the developed toner image T in a multilayered structure from the lower layer side in the figure, whereby sufficient exposure for applying the color information is carried out. As a result, sufficient color development is obtained so that a desired color taste in the image can be obtained.

Incidentally, at this time, in the case where the exposure light is laser light, with respect to the incidence of laser beams into the image carrier 10, in order to prevent return light to a monitor (photo detector) in the laser, the exposure light is usually inclined at several degrees (from 4 degrees to 13 degrees) However, in the invention, in carrying out the exposure for applying the color information, since the return light is absorbed by the toner, the amount of the return light becomes extremely small so that the exposure light can be made incident at an arbitrary angle including zero degree.

The timing and position control regarding the exposure for applying the color information will be hereunder described inclusive of the ion writing for forming the toner image.

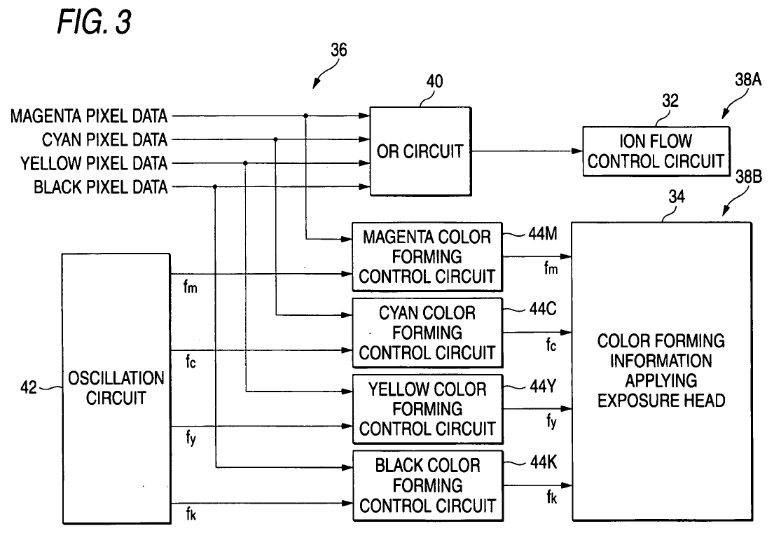

FIG. 3 shows a specific circuit block diagram of a printing controller. In this figure, a printer controller 36 is configured to have an OR circuit 40, an oscillation circuit 42, a magenta color forming control circuit 44M, a cyan color forming control circuit 44C, a yellow color forming control circuit 44Y, and a black color forming control circuit 44K. On the other hand, an electrostatic latent image forming part 38A is configured to have an ion flow control head 32 (electrostatic latent image forming unit), and a color information applying part 38B is configured to have a color information applying exposure head 34.

Image data resulting from converting inputted RGB signals into CMYK values by a non-illustrated interface (I/F) is further outputted as pixel data of magenta (M), cyan (C), yellow (Y) and black (K) from the interface (I/F) into the OR circuit 40. Here, the OR circuit 40 computes a logical add of CMYK and outputs it into the ion flow control head 32.

That is, the OR circuit 40 inputs data of the logical add including all of the pixel data of CMYK into the ion flow control head 32 and undergoes ion writing by minus ions against the image carrier 10 as described before. Accordingly, an electrostatic latent image is formed on the image carrier 10 based on the logical add data including all of the pixel data of CMYK.

Furthermore, the pixel data of CMYK is also supplied to the corresponding magenta color forming control circuit 44M to black color forming control circuit 44K and outputted into the color information applying exposure head 34 while being synchronized with oscillation signals fm, fc, fy and fk which are outputted from the oscillation circuit 42. That is, color development data corresponding to magenta (M), cyan (C), yellow (Y) and black (K), respectively is supplied into the color information applying exposure head 34, and light having a specific wavelength for keeping a color developed or non-color developed state is irradiated corresponding to the toner image T as formed on the image carrier 10. Accordingly, a photocuring reaction as described later or the like is generated within the toner which has received the irradiated light, thereby applying the color information.

For example, the color development signal fm as outputted from the magenta color forming control circuit 44M irradiates the foregoing λ_{B} light in the color developing part within the toner, thereby making the toner in a state such that it can be color developed in a magenta (M) color. Furthermore, the color development signal fc as outputted from the cyan color development control circuit 44C irradiates the foregoing λ_{C} light in the color developing part within the toner, thereby making the toner in a state such that it can be color developed in a cyan (C) color. In addition, the same is applicable to the yellow (Y) and black (K). The color development signals fy and fk as outputted from the yellow color development control circuit 44Y and the black color development control circuit 44K irradiate the foregoing λ_{A} light, or the foregoing λ_{A} light, λ_{B} light and λ_{C} light in the color developing part within the toner, thereby making the toner in a state such that it can be color developed in a yellow (Y) color or a black (K) color.

With respect to the color information applying step (measure) in the invention, while the mechanism in the case of carrying out the full color image formation has been described previously, the color information applying step in the invention may be a color information applying step for the mono color image formation for color developing any one color of yellow, magenta and cyan. In this case, only light having a specific wavelength corresponding to the desired color development among the foregoing yellow, magenta and cyan colors is irradiated from the color information applying exposure head 34. Other suitable conditions are the same as those at the time of the full color image formation.

Incidentally, in the foregoing exemplary embodiment, the color information applying step is carried out after the development and before the transfer. However, it is only required that the color information applying step in the invention is carried out at least before the fixing step, and for example, the color information applying step may be carried out after the transfer step as described later. However, in the case where the exposure for applying the color information is carried out after the transfer, from the standpoints of smoothness of the recording medium surface and accuracy of the color development position precision of a desired image, the exposure for applying the color information may be desirably carried out after the developing step and before the transfer step in view of the image quality.

Incidentally, in this stage, the toner image keeps the original color tone in a non-color developed state; and for example, when sensitized with a dye, the toner image bears merely a color tone of the dye.

Furthermore, in the case of using a light non-color development type toner, since the color information applying unit is not necessary at the time of forming a black-and-white image, a recording device for forming only a black-and-white image is provided at the beginning, and when a demand for colors increases, it is possible to add a color information applying unit later, thereby expanding the recording device as a color image forming recording device.

### <Transfer Step>

In the transfer step, the toner image T to which the color information has been given is collectively transferred into the recording medium S by the transfer device 18.

Here, as the transfer device 18, known transfer devices can be used for the transfer. For example, in the case of a contact system, a roll, a brush, a blade, and so on can be used; and in the case of a non-contact system, a corotron, a scorotron, a pin corotron, and so on can be used. Transfer by pressure or pressure and heat is also possible.

The transfer bias may be in the range of from 300 to 1,000 V (absolute value).

### <Fixing Step and Color Developing Step>

In the fixing step and color developing step, the toner image T which has been made in a color developable (non-color developed state keeping) state is color developed as described previously by heating the recording medium S by the fixing device 24. As the fixing device 24, known fixing units can be used. For example, a roll and a belt can be selected as a heating member and a pressurizing member, respectively; and a halogen vapor lamp, IH, and so on can be used as a heat source. The arrangement thereof can be made adaptive to various paper paths, for example, a straight path, a rear C path, a front C path, an S path, and a side C path.

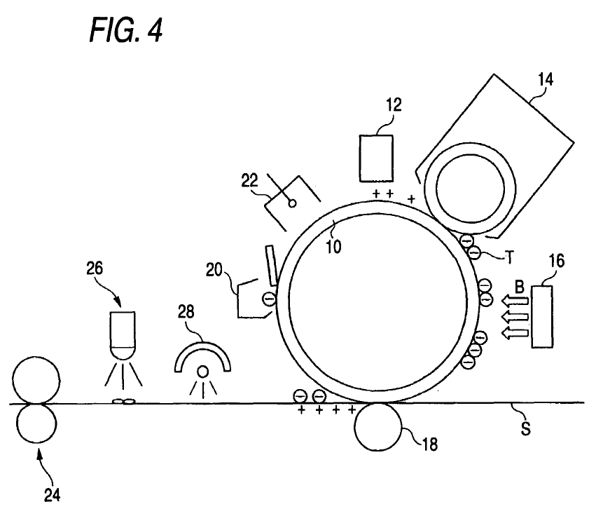

In the foregoing exemplary embodiment, while the fixing device 24 serves as both the color developing step and the fixing step, the color developing step may be provided separately from the fixing step. Though the position of the color developing device for carrying out the color developing step is not particularly limited, for example, as illustrated in FIG. 4, a color developing device 28 and the light irradiating device 26 can also be provided in an upstream side of the fixing device 24. In this way, since the heating temperature for the color development and the heating temperature for fixing the toner to the recording medium S can be individually controlled, it is possible to improve a degree of freedom in designing a color developing material, a toner binder material, and so on.

In this case, with respect to the color development method, since various methods can be thought corresponding to the color development mechanism of the toner particle, examples of the color developing device 28 (color developing unit) include a color developing device of specific light in a method in which a color development participating substance is cured or photo-decomposed in the toner by further using light having a different wavelength, thereby causing or controlling the color development; and a pressurizing device in a method in which an encapsulated color developing particle is broken by pressurization, thereby causing or controlling the color development.

However, in such a chemical reaction for causing the color development, since the reaction rate by migration or diffusion is generally slow, all of these methods are required to be given sufficient diffusion energy. At this point, it may be said that a method for promoting the reaction by heating is desirable. For that reason, it may be said that the use of the fixing device 24 which serves as both the color developing step and the fixing step is suitable inclusive of an aspect of saving of a space.

### <Light Irradiating Step>

In the light irradiating step, the image as obtained through the fixing and color developing steps is irradiated with light by the light irradiating device 26. In this way, since the reactive substance which remains in the color developing part in a state that it cannot be color developed can be decomposed or deactivated, it is possible to control more surely the fluctuation of color balance after the image formation or to remove or bleach the background color.

Incidentally, in the foregoing exemplary embodiment, while the light irradiating step is provided after the fixing step, in the case of a fixing method which does not undergo heat melting, for example, fixation under pressure for undergoing fixation using a pressure, the fixing step can be carried out after the light irradiating step.

Here, the light irradiating device 26 is not particularly limited so far as it is possible not to make the color development of the toner proceed any more, and known lamps, for example, a fluorescent lamp, LED, EL can be employed. Furthermore, for the purpose of undergoing color development of the toner, the light includes three wavelengths; the illuminance may be suitably in the range of from about 2,000 to 200,000 lux; and the exposure time may be suitably in the range of from 0.5 to 60 seconds.

### <Cleaning Step>

In the cleaning step, the residual toner TC which remains on the image carrier 10 after the transfer by the transfer device 18 is removed by the cleaning device 20. As this cleaning device 20, known cleaning devices to be utilized in an electrophotographic process which has hitherto been carried out by using a coloring agent such as pigments can be used, and a blade, a brush, and so on are useful.

### <Static Elimination Step>

In the static elimination step, the surface charge of the image carrier 10 is eliminated prior to the image forming process of a next cycle so as to have a potential of substantially zero by the static eliminator 22 which is arranged in an upstream side of the electrostatic latent image forming device 12. As the static eliminator 22, known static eliminators (for example, an AC corona discharger) to be utilized in an electrophotographic process which has hitherto been carried out by using a coloring agent such as pigments can be used.

### <Other Steps>

In addition to these steps, known steps to be utilized in an electrophotographic process which has hitherto been carried out by using a coloring agent such as pigments may be included. For example, the transfer step may be an intermediate transfer system including a first transfer step for transferring the toner image from the image carrier into an intermediate transfer body such as an intermediate transfer belt and a second transfer step for transferring the toner image as transferred onto the intermediate transfer body into the recording medium.

Furthermore, as described previously, the color information is stably kept in the toner since the color information has been given in the color information applying step until the color development step. Thus, it is not necessary to take into consideration the time from the color information applying step to the color development step. This makes it possible to accommodate a design over a wide speed range. Specifically, the linear velocity may be preferably in the range of from 10 to 500 mm/sec, and more preferably in the range of from 50 to 300 mm/sec. However, even in the case of carrying out the image formation at the foregoing linear velocity, the exposure time for applying the color information may be set up at a value which is determined from the linear velocity and the resolution.

Furthermore, what the color development information is stably kept also brings desirable effects in color tone stability in the image and reproducibility of the highlight image, which largely contributes to the full color image formation which is able to faithfully reproduce the inputted image information in a high image quality.

### <Toner to be Used>

Next, the configuration of the toner which is used according to an aspect of the invention will be hereunder described.

As described previously, the toner according to an aspect of the invention contains a first component and a second component that are present in an isolated state from each other and that undergo color development upon reaction with each other and a photocurable composition containing either the first component or the second component, and the photocurable composition keeps a cured or uncured state by applying the color information by light, thereby controlling a reaction for the color development. Furthermore, the color development mechanism of the toner is as described previously.

The toner according to an aspect of the invention contains, as color developable substances (color developing substances), a first component and a second component that are present in an isolated state from each other and that undergo color development upon reaction with each other. In this way, by undergoing the color development utilizing the reaction of two kinds of reactive components, it becomes easy to control the color development. Incidentally, though the foregoing first component and second component may be colored in advance prior to the state that they undergo color development, they may be especially substantially colorless substances.

According to an aspect of the invention, for the purpose of making it easy to control the color development, two kinds of reactive components that undergo color development upon reaction with each other are used as the color developing substances. However, when these reactive components are present within the same matrix in which the material diffusion is easy even in a state that the color information by light is not applied, there may be some possibilities that spontaneous color development proceeds at the time of storing or manufacturing the toner.

For that reason, the foregoing reactive components may be required to be contained for every kind thereof within a different matrix in which the material diffusion into a counterpart region is difficult (they are isolated from each other) unless the color information is applied.

In this way, for the purposes of inhibiting the material diffusion in a state that the color information by light is not applied and preventing spontaneous color development at the time of storing or manufacturing the toner, it may be desired that the first component of two kinds of reactive components is contained in a first matrix; that the second component is contained outside the first matrix (second matrix); and that a diaphragm which has a function to inhibit the material diffusion between the both matrixes and which, when an external stimulus such as heat is applied, has a function to make it possible to undergo the material diffusion between both of the matrixes depending upon the kind of stimulus or the intensity and a combination thereof is provided between the first matrix and the second matrix.

Incidentally, in order to arrange two kinds of reactive components in the toner while utilizing such a diaphragm, a microcapsule may be utilized.

In this case, for example, the toner according to an aspect of the invention may contain the first component of the two kinds of reactive components within a microcapsule and the second component outside the microcapsule, respectively. In this case, the inside of the microcapsule is corresponding to the first matrix, and the outside of the microcapsule is corresponding to the second matrix.

This microcapsule contains a core part and an outer shell for coating the core part and is not particularly limited so far as it is a microcapsule which has a function to inhibit the diffusion of the materials inside and outside the microcapsule unless an external stimulus such as heat is applied and which, when the external stimulus is applied, has a function to make it possible to undergo the diffusion of the materials inside and outside the microcapsule depending upon the kind of stimulus or the intensity and a combination thereof. Incidentally, at least one of the foregoing reactive components is contained in the core part.

Furthermore, the microcapsule may be a microcapsule which is able to undergo the material diffusion inside and outside the microcapsule by irradiating light or applying a stimulus such as pressure. However, the microcapsule may be especially suitably a heat responsible microcapsule which is able to undergo the material diffusion inside and outside the microcapsule by a heat treatment (the material permeability of the outer shell increases).

Incidentally, the material diffusion inside and outside the microcapsule in applying a stimulus may be desirably irreversible from the viewpoints of inhibiting a lowering of the color development density at the time of image formation and inhibiting a change of color balance of the image which has been allowed to stand under a high-temperature circumstance. Therefore, the outer shell which configures the microcapsule may desirably have a function to irreversibly increase the material permeability due to softening, decomposition, dissolution (compatibilization into surrounding members), deformation, and the like by a heat treatment or a stimulus such as light irradiation.

Next, a suitable configuration of the case where the toner contains a microcapsule will be hereunder described.

Such a toner may be suitably a toner containing a first component and a second component which undergo color development upon reaction with each other, a microcapsule and a photocurable composition having the second component dispersed therein and includes the following three exemplary embodiments.

That is, in the toner according to an aspect of the invention containing a first component and a second component that are present in an isolated state from each other and that undergo color development upon reaction with each other and a photocurable composition containing either the first component or the second component, the case of further utilizing a microcapsule may suitably include any of (1) an exemplary embodiment in which the microcapsule as dispersed in the photocurable composition is contained, the first component is contained within the microcapsule and the second component is contained in the photocurable composition (hereinafter referred to as “first exemplary embodiment”); (2) an exemplary embodiment in which the second component is contained within the microcapsule and the first component is contained in the photocurable composition (hereinafter referred to as “second exemplary embodiment”); and (3) an exemplary embodiment in which both the first component and the second component are contained in respective microcapsules and the photocurable composition is contained within the microcapsule containing either the first component or the second component (hereinafter referred to as “third exemplary embodiment”).

Of these three exemplary embodiments, the first exemplary embodiment is especially suitable from the viewpoints of stability before applying the color information by light, control of the color development, and so on. Incidentally, in the following description of the toner, while details will be given basically on the assumption of the toner of the first exemplary embodiment, the configuration, the materials, the manufacturing method, and so on of the toner of the first exemplary embodiment as described below can be, as a matter of course, applied or converted.

### (Microcapsule)

The microcapsule may be especially suitably a heat responsive microcapsule which is able to undergo the material diffusion inside and outside the microcapsule by a heat treatment. In this case, when the photocurable composition is cured upon irradiation with light for applying the color information, a combination including the presence or absence of exposure with light for the color information (applying a control stimulus) and a heat treatment (applying a color development stimulus) can be utilized as an external stimulus.

That is, in this case, the external stimulus which is applied for the purpose of controlling the reaction between the first component and the second component (controlling the color development reaction) includes a color development stimulus for undergoing a reaction (color development reaction) between the first component and the second component in a reactive state and a control stimulus for controlling a reaction between the first component and the second component (color development reaction) before the color development stimulus is given in a color developable state or a non-color developable state in applying the color development stimulus. Irradiation with light for applying the color information may be used as the control stimulus, and a heat treatment may be used as the color development stimulus.

Incidentally, while the heat responsible microcapsule (hereinafter sometimes referred to simply as “microcapsule”) is configured to have a core part containing the first component and an outer shell for coating the core part, the material which configures the outer shell may be made of a heat responsible material which makes it possible to undergo material diffusion inside and outside the microcapsule by a heat treatment. In this case, as the heat responsive material which is used as the outer shell of the microcapsule, a material may be used in which after completion of the heat treatment, decomposition, disappearance, destruction or the like in the outer shell structure occurs due to decomposition, softening, compatibilization with surrounding members, and the like by the heat treatment so that the material diffusion inside and outside the microcapsule can be permanently (irreversibly) kept with ease (for example, hear decomposing materials which are decomposed by heating, thermoplastic materials such as thermoplastic resins, and heat fusible materials which become compatible with surrounding members by heating).

In this way, since the material permeability of the outer shell of the microcapsule is irreversibly increased and its state is kept at the time of the color development step, the first component and the second component which have become in a reactive state after applying the control stimulus (irradiation with light for applying the color information) (or which continue to keep a reactive state even after applying the control stimulus) are easy for working to sufficiently react with each other. Therefore, not only it is possible to secure a sufficient color development density at the time of the color development, but also even when a printed matter is left under a high-temperature circumstance after the image formation, it is possible to inhibit a loss of color balance as caused due to the decoloration of the once formed image.

### (Color Development Type of Toner (Light Color Development Type or Light Non-Color Development Type))

Incidentally, the toner according to an aspect of the invention using a combination of the foregoing heat responsible microcapsule and photocurable composition may be especially suitably any one of the following two types.

That is, examples of the toner include (1) a toner of a type in which when the photocurable composition is in an uncured state, the toner keeps a color undevelopable state and by curing the photocurable composition upon irradiation with light having a specific wavelength for curing the photocurable composition, the toner is irreversibly controlled from the color undevelopable state into a color developable state (hereinafter referred to as “light color development type toner”) ; and (2) a toner of a type in which when the photocurable composition is in an uncured state, the toner keeps a color developable state and by curing the photocurable composition upon irradiation with light having a specific wavelength for curing the photocurable composition, the toner is irreversibly controlled from the color developable state into a color undevelopable state (hereinafter referred to as “light non-color development type toner”).

A major difference between the light color development type toner and the light non-color development type toner resides in the materials which configure the photocurable composition. In the light color development type toner, at least the second component (which is not photopolymerizable) and the photopolymerizable compound are contained in the photocurable composition, whereas in the light non-color development type toner, at least the second component containing a photopolymerizable group in the molecule thereof is contained in the photocurabie composition.

Incidentally, a photopolymerization initiator may be especially suitably contained in the photocurable composition which is used in the light color development type toner and the light non-color development type toner. If desired, other various materials may be contained.

As the photopolymerizable compound and the second component which are used in the light color development type toner, materials in which a mutual action works between the both in a state that the photocurable composition is uncured, whereby the material diffusion of the second component in the photocurable composition is inhibited, and the mutual action between the both is reduced in a state after curing of the photocurable composition due to the irradiation with light for applying the color information (polymerization of the photopolymerizable compound), whereby the diffusion of the second component in the photocurable composition becomes easy are used (incidentally, details of these materials which configure the photocurable composition will be described later).

Accordingly, in the light color development type toner, the second component is trapped in the photopolymerizable compound as it stands at the time when the light for applying the color information is not irradiated and the photocurable composition is in an uncured state. Therefore, even when a stimulus for increasing the material permeability of the outer shell of the microcapsule in this state is applied, the second component cannot come into contact with the first component in the microcapsule, and the state that the reaction (color development reaction) between the first component and the second component is impossible (color undevelopable state) is kept.

On the other hand, when light for applying the color information having a wavelength at which the photocurable composition is cured is irradiated to cure the photocurable composition, the material diffusion of the second component as contained in the photocurable composition becomes easy. Therefore, when the material permeability of the outer shell of the microcapsule is increased in this state by applying a color development stimulus such as a heat treatment, the toner becomes in a state that the reaction (color development reaction) between the first component within the microcapsule and the second component in the photocurable composition is possible (color developable state).

Incidentally, since the curing reaction of the photocurable composition is irreversible, when the toner is controlled once in a color developable state, this state is permanently kept.

Accordingly, for example, in the case of using a heat responsible microcapsule as the microcapsule, when the photocurable composition is cured upon irradiation with light for applying the color information to control the toner in a color developable state, followed by a heat treatment, the material permeability of the outer shell of the heat responsible microcapsule is increased so that the first component and the second component react with each other, the toner undergoes color development in a prescribed color, and this color developed state can be stably kept. On the other hand, when light for applying the color information which is able to cure the photocurable composition is not irradiated, the photocurable composition continuously keeps an uncured state, and even when the material permeability of the outer shell of the heat responsible microcapsule is increased upon heat treatment, the first component and the second component cannot react with each other. Accordingly, for example, when the color of the toner before the color development is colorless and transparent, this state is stably kept.

In the light color development type toner as described previously, the color development reaction between the first component and the second component is controlled by a two-stage process including (1) a reaction for curing the photocurable composition upon irradiation with light for applying the color information which is able to cure the photocurable composition and (2) an increase of the material permeability of the outer shell of the microcapsule by applying a color development stimulus such as a heat treatment.

On the other hand, a color development reaction of a toner utilizing a light responsible bimolecular film as a capsule wall as described in JP-A-2003-330228 is also a two-stage process in which the toner is irradiated with light to render it in a state that a color development reaction (material diffusion) is possible, and the material diffusion by heating is promoted to undergo the reaction.

However, the first stage process for determining whether or not the toner is controlled from the color undevelopable state to the color developable state (curing of the photocurable composition) is irreversible in the light color development type toner, whereas the first stage process (photoisomerization reaction of a bimolecular film) is reversible in the toner as described in JP-A-2003-330228.

Accordingly, in the toner as described in JP-A-2003-330228, since the first stage process is reversible, the second stage color development reaction is continuously influenced large or small by the first stage process so that the control of the color development reaction is difficult. Therefore, the color development density at the time of image formation generates a scattering.

On the other hand, in the light color development toner, since the second stage color development reaction can be controlled without being influenced by the first stage process, the control of the color development reaction is easy, and insurance of a color development density at the time of image formation and control of a change of color balance after the image formation are easy. In addition, by rendering the increase of the material permeability of the outer shell of the microcapsule irreversible, more precious control becomes possible. Moreover, since the degradation of the color development density can be controlled by a degree of curing (polymerization) of the photocurable composition, which is an irreversible reaction, the control of the degradation of the color development density is extremely easy, too.

Incidentally, besides the type using, as the photo-polymerizable compound, a photopolymerizable compound having a characteristic of trapping the second component at the time when the photocurable composition is in an uncured state as described previously (the toner of this type will be sometimes referred to as “first color development type toner”), the light color development type toner may be a type using a photopolymerizable compound containing a decoloring reactive group which hinders the color development reaction between the first component and the second component by a reaction with the first component within the molecule (the toner of this type will be sometimes referred to as “second color development type toner”).

In the second light color development type toner, for example, in the case of using a heat responsible microcapsule as the microcapsule, when light for applying the color information having a wavelength at which the photocurable composition is cured is irradiated, the photocurable composition is cured (that is, the photo-polymerizable compound containing a decoloring reactive group is polymerized). Accordingly, even when a heat treatment is subsequently carried out, the color development reaction between the first component and the second component is not hindered by the decoloring reactive group (which even when heated, has become unable to undergo the material diffusion due to the polymerization) so that the toner can undergo color development. On the other hand, in the case of carrying out a heat treatment without being irradiated with light for applying the color information having a wavelength at which the photocurable composition is cured, the decoloring reactive group reacts with the first component to hinder the color development reaction between the first component and the second component so that the toner cannot undergo color development.

In this way, in the second light color development type toner, by keeping it in the color undevelopable state at the time when the photocurable composition is in an uncured state and curing the photocurable composition upon irradiation with light having a wavelength characteristic of curing the photocurable composition, the toner is controlled from the color undevelopable state to the color developable state.

Furthermore, in the light non-color development type toner, since the second component itself is photopolymer-izable, even when irradiated with light for applying the color information, so far as the wavelength of this light is not a wavelength at which the photocurable composition is cured, the state that the material diffusion of the second component which is contained in the photocurable composition can be easily kept. Accordingly, when the material permeability of the outer shell of the microcapsule is increased by applying a color development stimulus such as a heat treatment in this state, the toner becomes in a state that the reaction (color development reaction) between the first component within the microcapsule and the second component in the photocurable composition is possible (color developable state).

On the other hand, when the photocurable composition is cured upon irradiation with light for applying the color information having a wavelength at which the photocurable composition is cured, since polymerization is generated among the second components which are contained in the photocurable composition, the material diffusion of the second component which is contained in the photocurable composition becomes extremely difficult. Therefore, even when a stimulus to increase the material permeability of the outer shell of the microcapsule in this state is applied, the second component is unable to come into contact with the first component in the microcapsule, and the state that the reaction (color development reaction) between the first component and the second component is impossible (color undevelopable state) is kept.

Incidentally, since the curing reaction of the photocurable composition is irreversible, when the toner is once controlled in a color undevelopable state, this state is permanently kept.

Accordingly, for example, in the case of using a heat responsible microcapsule as the microcapsule, by controlling the toner in a color undevelopable state upon irradiation with light for applying the color information to cure the photocurable composition, even when the material permeability of the outer shell of the heat responsible microcapsule is increased by the subsequent heat treatment, the first component and the second component are unable to react with each other. Accordingly, for example, when the color of the toner before the color development is colorless and transparent, this state is stably kept.

On the other hand, when the heat treatment is carried out in a state that the photocurable composition is uncured, namely in a state that the toner is color developable, the material permeability of the outer shell of the heat responsible microcapsule is increased so that the first component and the second component react with each other. Thus, the toner is color developed in a prescribed color, and this color development state can be stably kept.

In the light non-color development type toner as described previously, the color development reaction between the first component and the second component is controlled in a substantially one-stage process such that the material permeability of the outer shell of the microcapsule is increased by applying a color development stimulus such as a heat treatment in a state that the photocurable composition is uncured (a state not via a process for irradiating light for applying the color information having a wavelength for curing the photocurable composition).

Therefore, the control of the color development reaction is easy, and insurance of a color development density at the time of image formation and control of a change of color balance after the image formation are easy. In addition, by rendering the increase of the material permeability of the outer shell of the microcapsule irreversible, more precious control becomes possible. Moreover, since the degradation of the color development density can be controlled by a degree of curing (polymerization) of the photocurable composition, which is an irreversible reaction, the control of the degradation of the color development density is extremely easy, too.

On the other hand, in the case where the toner is not intended to be color developed, when the photocurable composition is cured upon irradiation with light for applying the color information prior to increasing the material permeability of the outer shell of the microcapsule by applying a color development stimulus such as a heat treatment, the color undevelopable state can be stably kept.

On the other hand, a color development reaction of a toner utilizing a light responsible bimolecular film as a capsule wall as described in JP-A-2003-330228 is also a two-stage process in which the toner is irradiated with light to render it in a state that a color development reaction (material diffusion) is possible, and the material diffusion by heating is promoted to undergo the reaction, and its color development control is complicated. In addition, in the toner as described in JP-A-2003-330228, since the first stage process is reversible, the second stage color development reaction is continuously influenced large or small by the first stage process so that the control of the color development reaction is difficult. Therefore, the color development density at the time of image formation generates a scattering.

Next, with respect to the structure of the toner which may be suitable according to an aspect of the invention, the case containing the foregoing photocurable composition and the microcapsule which is dispersed in this photocurable composition will be described below in more detail.

In this case, though the toner may be a toner containing only one color developing part containing the photocurable composition and the microcapsule which is dispersed in this photocurable composition, it may be suitably a toner containing two or more of such a color developing part. The term “color developing part” as referred to herein means a continuous region which is color developable in a specific one color in applying the foregoing external stimulus.

Incidentally, in the case where the toner contains two or more color developing parts, though the toner may contain one kind of a color developing part which is color developable in the same color, the toner may especially suitably contain two or more kinds of color developing parts which are color developable in a different color from each other. This is because while the color which one toner particle can undergo color development is limited to one kind in the former case, it can be made of two or more kinds in the latter case.

For example, examples of two or more kinds of color developing parts which are color developable in a different color from each other include a combination containing a yellow color developing part which is color developable in a yellow color, a magenta color developing part which is color developable in a magenta color and a cyan color developing part which is color developable in a cyan color.

In this case, for example, in the case where only one kind of color developing part is color developed by applying an external stimulus, the toner can be color developed in any one color of yellow, magenta or cyan; and in the case where two kinds of color developing parts are color developed, the toner can be color developed in a combined color of colors as generated by the color development of these two kinds of color developing parts. Thus, it is possible to express various colors by one toner particle.

Incidentally, in the case where the toner contains two or more kinds of color developing parts which are color developable in a different color from each other, the control of colors as color developed can be realized by making the wavelength of light to be used for curing the photocurable composition which is contained in the color developing part of each kind different in addition to making the kind or combination of the first component and the second component which are contained in the color developing part of each kind different.

That is, in this case, since the wavelength of the light which is necessary for curing the photocurable composition as contained in the color developing part is different in every kind of the color developing part, plural kinds of lights for applying the color information corresponding to the kind of the coloring part may be used as a control stimulus. Incidentally, in order to make the wavelength of the light which is necessary for curing the photocurable composition as contained in the color developing part different, a photopolymerization initiator which is sensitive to light having a different wavelength in every kind of the color developing part may be contained in the photocurable composition.

For example, in the case where the toner contains three kinds of color developing parts which are color developable in yellow, magenta and cyan colors, respectively, when a material which is cured in response to any light having a wavelength of 405 nm, 532 nm or 657 nm is used as the photocurable composition which is contained in the color developing part of each kind, by properly using light for applying the color information having three different wavelengths (light having a specific wavelength), the toner can be color developed in a desired color.

Incidentally, though the wavelength of the light for applying the color information can be selected among wavelengths in a visible region, it may be selected among wavelengths in an ultraviolet region. When the wavelength is a short wavelength, there is brought a merit that the beam size can be easily reduced (possible for high definition). Examples of a light source of such a wavelength include a wavelength conversion solid-state SHG laser (converting the basic wavelength to ½) and a gas laser.

Furthermore, by selecting the wavelength of the light for applying the color information from not a visible region but an infrared region, as hitherto known, there are brought merits that the price of a light emitting device itself is cheap and that a high output is likely obtained.

The toner which is used according to an aspect of the invention may be a toner containing a matrix containing, as the major component, a binding resin the same as that used in conventional toners using a coloring agent such as pigments. In this case, each of the foregoing two or more color developing parts may be suitably dispersed as a granular capsule in the matrix (one color developing part in a capsule form will be hereinafter sometimes referred to as “photosensitive or thermosensitive capsule”). Furthermore, a surface lubricant or various additives may be contained in the matrix in the same manner as in conventional toners using a coloring agent such as pigments.

The photosensitive or thermosensitive capsule is not particularly limited so far as it contains a core part containing a microcapsule and a photocurable composition and an outer shell for coating the core part and the core part can stably hold during a manufacturing process of a toner as described later or at the time of storing the toner such that the microcapsule or the photocurable composition within the photosensitive or thermosensitive capsule lest it leak outside the photosensitive or thermosensitive capsule.

However, according to an aspect of the invention, in the manufacturing process of a toner as described later, in order to prevent the matters that the second component permeates through the outer shell and flows out into the matrix outside the photosensitive or thermosensitive capsule and that the second component in the photosensitive or thermosensitive capsule which is color developable in other color permeates through the outer shell and flows in, the photosensitive or thermosensitive capsule may suitably contain, as the major component, a water-insoluble material such as binding resins or surface lubricants made of a water-insoluble resin. Of these, water-soluble resins such as styrene/acrylic copolymers and polyesters may be suitably used.

Incidentally, besides the foregoing structure in which a photosensitive or thermosensitive capsule (color developing part) is dispersed in a matrix (this structure will be hereinafter sometimes referred to as “color developing part-dispersed structure”), the toner which is used according to an aspect of the invention may be of a structure in which two or more color developing parts are stratified (one stratified color developing part will be hereinafter sometime referred to as “photosensitive or thermosensitive layer”).

Here, examples of an exemplary embodiment of the case where two or more color developing parts are stratified include (1) an exemplary embodiment which is made of a photosensitive or thermosensitive layer for forming a core layer and one or more photosensitive or thermosensitive layers which are successively stacked on the core layer so as to coat the core layer (hereinafter sometimes referred to as “concentric circle structure”); (2) an exemplary embodiment in which a cross section as obtained by cutting the toner from a prescribed direction is made of two or more photosensitive or thermosensitive layers which are stacked in a stripe form (hereinafter sometimes referred to as “stripe structure”); and (3) an exemplary embodiment in which a cross section as obtained by cutting the toner from a prescribed direction is divided into folding fan-like forms with the center of the toner being a cardinal point and an area of each of the folding fans is made of a photosensitive or thermosensitive layer (hereinafter sometimes referred to as “folding fan structure”).

Incidentally, in all of the concentric structure, the stripe structure and the folding fan structure, it may be especially suitable that an interlayer containing a material configuring the outer shell of the foregoing photosensitive or thermosensitive capsule is provided between the adjacent two photosensitive or thermosensitive layers. Furthermore, the interlayer may contain a surface lubricant and various additives as in the case of conventional toners using a coloring agent such as pigments. Moreover, a coating layer containing a binding resin may be provided on the outermost surface layer in these three kinds of toners.

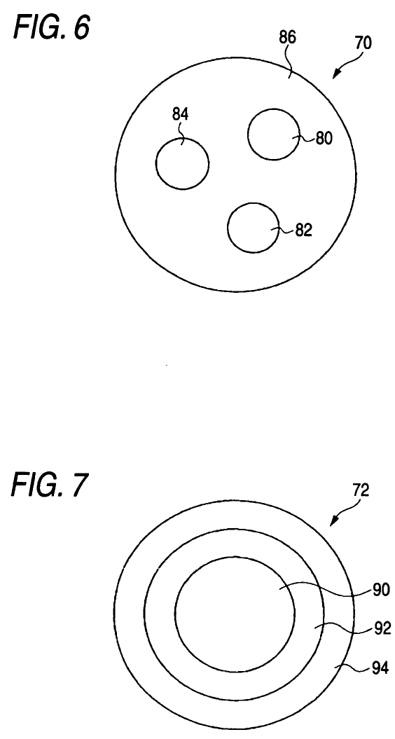

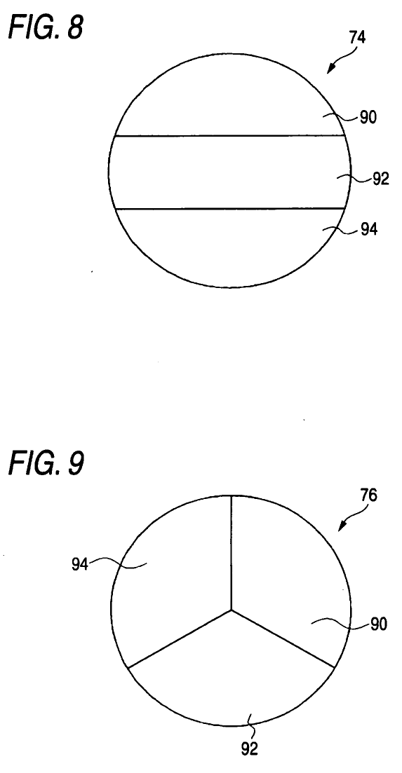

FIG. 6 is a schematic cross-sectional view to show one example of the case where the toner according to an aspect of the invention contains a matrix and color developing parts as dispersed in the matrix; FIG. 7 is a schematic cross-sectional view to show one example of the case where the structure of the toner according to an aspect of the invention is a concentric circle structure; FIG. 8 is a schematic cross-sectional view to show one example of the case where the structure of the toner according to an aspect of the invention is a stripe structure; and FIG. 9 is a schematic cross-sectional view to show one example of the case where the structure of the toner according to an aspect of the invention is a folding fan structure.

In FIGS. 6 to 9, numerals 70, 72, 74 and 76 each denotes a toner; a numeral 80 denotes a first color developing part; a numeral 82 denotes a second color developing part; a numeral 84 denotes a third color developing part; a numeral 86 denotes a matrix; a numeral 90 denotes a first photosensitive or thermosensitive layer; a numeral 92 denotes a second photosensitive or thermosensitive layer; and a numeral 94 denotes a third photosensitive or thermosensitive layer. Incidentally, FIGS. 6 to 9 each shows only a principal part; and descriptions regarding the interlayer which is provided between the adjacent two photosensitive or thermosensitive layers, the coating layer which is provided on the outermost surface of the toner, and so on are omitted.

In the toner 70 as illustrated in FIG. 6, three kinds of the color developing parts 80, 82 and 84 are dispersed in the matrix 86, and for example, the color developing parts are color developable yellow, magenta and cyan, respectively.

Furthermore, the toner 72 as illustrated in FIG. 7 is made of the first photosensitive or thermosensitive layer 90 which forms a core layer and the second photosensitive or thermosensitive layer 92 and the third photosensitive or thermosensitive layer 94 as successively stacked on the first photosensitive or thermosensitive layer 90 which configures the core layer; the toner 74 as illustrated in FIG. 8 is made of the stripe-shaped second photosensitive or thermosensitive layer 92 and the stripe-shaped first photosensitive or thermosensitive layer 90 and the stripe-shape third photosensitive or thermosensitive layer 94 as arranged in the both sides of the second photosensitive or thermosensitive layer 92; and the toner 76 as illustrated in FIG. 9 is a toner in which three regions as trisected in a folding fan-like form with a central part of the toner 76 being a cardinal point are made of the three photosensitive or thermosensitive layers 90, 92 and 94, respectively. In the toners 72, 74 and 76 as illustrated in FIGS. 7 to 9, for example, the three photosensitive or thermosensitive layers 90, 92 and 94 are color developable yellow, magenta and cyan, respectively.

Incidentally, for example, the toner having a structure in which the color developing parts are dispersed in the matrix or having a concentric circle structure can be prepared by utilizing an emulsion aggregation method as described later; and the toners having a concentric circle structure, a stripe structure or a folding fan structure can be prepared by utilizing a wet preparation method using a microreactor.

Furthermore, the toner according to an aspect of the invention may be a toner containing only one color developing part in addition to the toner having two or more color developing parts as in the color developing part-dispersed structure, the concentric circle structure, the stripe structure or the folding fan structure as exemplified in FIGS. 6 to 9. In such case, one color developing part itself can be used as a toner.

### (Configuring Materials of Light Non-Color Development Type Toner and the Like)

Next, in the case where the toner according to an aspect of the invention is a light non-color development type toner, the toner configuring materials which are used and the materials and methods which are employed in preparing the respective toner configuring materials will be hereunder described in detail.

In this case, at least the first component, the second component, the microcapsule containing the first component, and the photocurable composition containing the second component are used in the toner; it may be especially suitable that a photopolymerization initiator is contained in the photocurable composition; various auxiliaries may be contained. Furthermore, the first component may be present in a solid state within the microcapsule (core part) or may be present together with a solvent.

Incidentally, in the light non-color development toner, an electron donating colorless dye or a diazonium salt compound or the like is used as the first component; and a photopolymerizable group-containing electron accepting compound or a photopolymerizable group-containing coupler compound or the like is used as the second component.

In addition to the foregoing enumerated compounds, various materials such as a binding resin, a surface lubricant, an internal additive, and an external additive, the same materials that configure a conventional toner using a coloring agent can be further properly used as needed. The respective materials and the like will be hereunder described in more detail.

### —First Component and Second Component—

As the combination of the first component and the second component, the following combinations (a) to (r) may be enumerated (in the following examples, the former expresses the first component, and the latter expresses the second component).
(a) Combination of an electron donating colorless dye and an electron accepting compound
(b) Combination of a diazonium salt compound and a coupling component (hereinafter properly referred to as “coupler compound”)
(c) Combination of an organic acid metal salt (for example, silver behenate and silver stearate) and a reducing agent (for example, protocatechinic acid, spiroindane, and hydroquinone)
(d) Combination of a long-chain fatty acid iron salt (for example, ferric stearate and ferric myristate) and a phenol (for example, tannic acid, gallic acid, and ammonium salicylate)
(e) Combination of an organic acid heavy metal salt (for example, nickel, cobalt, lead, copper, iron, mercury or silver salts of acetic acid, stearic acid, palmitic acid, etc.) and an alkali metal or alkaline earth metal sulfide (for example, calcium sulfide, strontium sulfide, and potassium sulfide); or combination of the foregoing organic acid heavy metal salt and an organic chelating agent (for example, s-diphenylcarbazide and diphenylcarbazone)
(f) Combination of a heavy metal sulfate (for example, sulfates of silver, lead, mercury, sodium, etc.) and a sulfur compound (for example, sodium tetrathionate, sodium thiosulfate, and thiourea)
(g) Combination of an aliphatic ferric salt (for example, ferric stearate) and an aromatic polyhydroxy compound (for example, 3,4-hydroxytetraphenylmethane)
(h) Combination of an organic acid metal salt (for example, silver oxalate and mercury oxalate) and an organic polyhydroxy compound (for example, polyhydroxy alcohol, glycerin, and glycols)
(i) Combination of a fatty acid ferric salt (for example, ferric polargonate and ferric laurate) and a thiocetyl carbazide or isothiocetyl carbazide derivative
(j) Combination of an organic acid lead salt (for example, lead caprorate, lead polargonate, and lead behenate) and a thiurea derivative (for example, ethylene thiourea and N-dodecyl thiourea)
(k) Combination of a higher aliphatic heavy metal salt (for example, ferric stearate and copper stearate) and a lead dialkyldithiocarbamate
(l) Combination capable of forming an oxazine dye (for example, a combination of resorcin and a nitroso compound)
(m) Combination of a formazan compound and a reducing agent and/or a metal salt
(n) Combination of a protected dye (or leuco dye) precursor and a deprotecting agent
(o) Combination of an oxidation type color former and an oxidizing agent
(p) Combination of a phthalonitrile and a diiminoisoindoline (combination from which phthalocyanine is formed)
(q) Combination of an isocyanate and a diiminoisoindoline (combination from which a color pigment is formed)
(r) Combination of a pigment precursor and an acid or a base (combination from which a pigment is formed)

The above-enumerated first component which is used according to an aspect of the invention may be suitably a substantially colorless electron donating colorless dye or diazonium salt compound.

As the foregoing electron donating colorless dye, dyes which have hitherto been known can be used, and all of dyes capable of reacting with the foregoing second component to undergo color development can be used. Specific examples thereof include various compounds such as phthalide based compounds, fluorane based compounds, phenothiazine based compounds, indolylphthalide based compounds, leuco auramine based compounds, rhodamine lactam based compounds, triphenylmethane based compounds, triazene based compounds, spiropyran based compounds, pyridine based compounds, pyrazine based compounds, and fluorene based compounds. However, it should not be construed that the electron donating colorless dye which can be used according to an aspect of the invention is limited thereto.

According to an aspect of the invention, in the case of forming a full color image, it may be especially suitable to use electron donating colorless dyes for cyan, magenta and yellow color developing dyes.

As the cyan, magenta and yellow color developing dyes, respective dyes as described in U.S. Pat. No. 4,800,149, etc. can be used. In addition, dyes as described in U.S. Pat. No. 4,800,148, etc. can also be used as the electron donating colorless dye for yellow color developing dye; and dyes as described in JP-A-63-53542, etc. can also be used as the electron donating colorless dye for cyan color developing dye.

For example, in the case where the toner has a structure as exemplified in FIGS. 6 to 9, the use amount of the electron donating colorless dye may be suitably from 0.01 to 3 g/m², and more suitably from 0.1 to 1 g/m² in the photosensitive or thermosensitive capsule (or the photosensitive or thermosensitive layer). When the use amount is less than 0.01 g/m², a sufficient color development density may not be possibly obtained, whereas when it exceeds 3 g/m², the formation of a photosensitive or thermosensitive capsule (or a photosensitive or thermo-sensitive layer) may possibly become difficult. With respect to the use amount of the electron donating colorless dye, the same is applicable to the case where the toner according to an aspect of the invention has a structure containing only one color developing part.

Examples of the diazonium salt compound which can be used include compounds represented by the following formula (1).

Ar—N₂⁺X⁻ (1)

In the formula (1), Ar represents an aromatic ring group; and X⁺ represents an acid anion.

This diazonium salt compound is a compound which generates a coupling reaction with a coupler by heating to undergo color development or is decomposed by light. It is possible to control its maximum absorption wavelength by the position or kind of the substituent in the Ar moiety.

The maximum absorption wavelength λₘₐₓ of the diazonium salt compound which is used according to an aspect of the invention may be suitably not more than 450 nm, and more suitably from 290 to 440 nm from the standpoint of the effect. As the diazonium salt compound which is used according to an aspect of the invention, diazonium salt compounds having not more than 12 carbon atoms and having a solubility in water of not more than 1% by mass and a solubility in ethyl acetate of 5% by mass or more may be used.

The foregoing diazonium salt compound may be used singly or in combination of two or more kinds thereof depending upon various purposes such as hue adjustment.

For example, in the case where the toner according to an aspect of the invention has a structure as exemplified in FIGS. 6 to 9, the use amount of the diazonium salt compound may be suitably from 0.01 to 3 g/m²₁ and more suitably from 0.02 to 1.0 g/m² in the photosensitive or thermosensitive capsule (or photosensitive or thermosensitive layer). When the use amount is less than 0.01 g/m², sufficient color developing properties may not be possibly obtained, whereas when it exceeds 3 g/m², the sensitivity may possibly be reduced, or the time of the light irradiation which is carried out after the fixation as the need arises may possibly be required to be prolonged. Incidentally, with respect to the use amount of the diazonium salt compound, the same is applicable to the case where the toner has a structure containing only one color developing part.

The second component which is used according to an aspect of the invention is a substantially colorless compound having a photopolymerizable group and a site capable of reacting with the first component to cause color development within the same molecule. All of compounds having both a function to react with the first component (for example, photopolymerizable group-containing electron accepting compounds and photopolymerizable group-containing coupler compound) to cause color development and a function to react with light to cause polymerization and curing can be used as the second component.

As the photopolymerizable group-containing electron accepting compound, namely the compound containing an electron accepting group and a photopolymerizable group in the same molecule, all compounds containing a photopolymerizable group and capable of reacting with the electron donating colorless dye which is one example of the first component to cause color development and being cured upon photopolymerization can be used.

Examples of the electron accepting compound include compounds which can be synthesized while referring to 3-halo-4-hydroxybenzoic acids as described in JP-A-4-226455; methacryloxyethyl ester or acryloxyethyl ester of hydroxyl group-containing benzoic acid as described in JP-A-63-173682; ester of hydroxyl group-containing benzoic acid and hydroxymethylstyrene as described in JP-A-59-83693, JP-A-60-141587 and JP-A-62-99190; hydroxystyrene as described in European Patent No. 29323; N-vinylimidazole complexes of a zinc halide as described in JP-A-62-167077 and JP-A-62-16708; and electron accepting compounds as described in JP-A-63-317558.

Of these compounds containing an electron accepting group and a polymerizable group within the same molecule, 3-halo-4-hydroxybenzoic acids represented by the following general formula may be suitable.

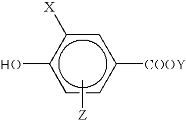

In the foregoing general formula, X represents a halogen atom and may be suitably a chlorine atom; Y represents a polymerizable ethylene group-containing monovalent group and may be suitably an aralkyl group, an acryloyloxyalkyl group, or a methacryloyloxyalkyl group, containing a vinyl group, and more suitably an acryloyloxyalkyl group having from 5 to 11 carbon atoms or a methacryloyloxyalkyl group having from 6 to 12 carbon atoms; and Z represents a hydrogen atom, an alkyl group, or an alkoxy group.

The polymerizable group-containing electron accepting compound is used in combination with the foregoing electron donating colorless dye. In this case, the use amount of the electron accepting compound may be suitably from 0.5 to 20 parts by mass, and more suitably from 3 to 10 parts by mass based on one mass by weight of the electron donating colorless dye to be used. When the use amount of the electron accepting compound is less than 0.5 parts by mass, a sufficient color development density may not be possibly obtained, whereas when it exceeds 20 parts by mass, a lowering of the sensitivity may possibly occur or the formation of a photosensitive or thermosensitive capsule (or a photosensitive or thermo-sensitive layer) may possibly become difficult.

Furthermore, as the foregoing photopolymerizable group-containing coupler compound, all compounds containing a photopolymerizable group and capable of reacting with the diazonium salt compound which is one example of the first component to cause color development and being cured upon photopolymerization can be used. The coupler compound is a compound capable of forming a dye upon coupling with a diazo compound in a basic atmosphere and/or a neutral atmosphere, and plural kinds thereof can be used depending upon various purposes such as hue adjustment.

The coupler compound is used in combination with the diazonium salt compound. For example, in the case where the toner according to an aspect of the invention has a structure as exemplified in FIGS. 6 to 9, the use amount of the coupler compound may be suitably from 0.02 to 5 g/m², and more suitably from 0.1 to 4 g/m² from the standpoint of the effect in the photosensitive or thermosensitive capsule (or photosensitive or thermo-sensitive layer). When the use amount is less than 0.02 g/m², the color developing properties may possibly be deteriorated, whereas when it exceeds 5 g/m², the formation of a photosensitive or thermosensitive capsule (or a photosensitive or thermosensitive layer) may possibly become difficult. Incidentally, with respect to the use amount of the coupler compound, the same is applicable to the case where the toner according to an aspect of the invention has a structure containing only one color developing part.

Furthermore, the use amount of the coupler compound may be suitably from 0.5 to 20 parts by mass, and more suitably from 1 to 10 parts by mass based on one part by mass of the diazonium salt compound. When the use amount of the coupler compound is less than 0.5 parts by mass, sufficient color developing properties may not be possibly obtained, whereas when it exceeds 20 parts by mass, the formation of a photosensitive or thermosensitive capsule (or a photosensitive or thermosensitive layer) may possibly become difficult.

Though the coupler compound can be used after adding a water-soluble polymer together with other components and solid dispersing by a sand mill or the like, it can also be used as an emulsion after emulsification together with a suitable emulsification auxiliary. Here, the solid dispersing or emulsification method is not particularly limited and can be properly selected among known methods. Details of the method are described in JP-A-59-190886, JP-A-2-141279, and JP-A-7-17145.

Furthermore, for the purpose of promoting the coupling reaction, organic bases such as tertiary amines, piperidines, piperazines, amidines, formamidines, pyridines, guanizines, and morpholines may be used.

These organic bases are described in JP-A-57-123086, JP-A-60-49991, JP-A-60-94381, and Japanese Patent Application Nos. 7-228731, 7-235157 and 7-235158.

The use amount of the organic base is not particularly limited and may be suitably from 1 to 30 moles per mole of the diazonium salt. The organic base may be used singly or in combination of two or more kinds thereof.

In addition, for the purpose of promoting the color development reaction, a color developing auxiliary can be added. Examples of the color developing auxiliary include phenol derivatives, naphthol derivatives, alkoxy-substituted benzenes, alkoxy-substituted naphthalenes, hydroxy compounds, carboxylic acid amide compounds, and sulfonamide compounds. It is thought that such a compound produces a high color development density because it lowers a melting point of the coupler compound or the basic substance or has an action to improve heat permeability of the microcapsule wall (outer shell).

### —Photopolymerization Initiator—

Next, the photopolymerization initiator which is used according to an aspect of the invention will be hereunder described. The photopolymerization initiator generates a radical upon irradiation with light for applying the color information, thereby enabling one to cause a polymerization reaction within the photocurable composition and promote that reaction. The photocurable composition is cured by this polymerization reaction.

The photopolymerization initiator can be properly selected among known photopolymerization initiators. Of these, substances containing a spectral sensitizing compound having a maximum absorption wavelength at from 300 to 1,000 nm and a compound capable of mutually acting with the spectral sensitizing compound may be suitable.

However, so far as the compound capable of mutually acting with the spectral sensitizing compound is a compound having a structure containing both a dye segment having a maximum absorption wavelength at from 300 to 1,000 nm and a borate segment, the spectral sensitizing dye may not be used.

Examples of the known photopolymerization initiator include those as described in U.S. Pat. No. 4,950,581 (column 20, line 35 to column 21, line 35). Also, there are enumerated triazine compounds as described in EP-A-137452, DE-A-2718254, DE-A-2243621, and U.S. Pat. No. 4,950,581 (column 14, line 60 to column 18, line 44), such as triazine and trihalomethyltriazines such as 2,4-bis(trichloromethyl)-6-(4-styrylphenyl)-s-triazine.

In the case where the photopolymerization initiator is used in a hybrid system, there can also be enumerated cationic photopolymerization initiators in addition to free radical curing agents. As the cationic polymerization initiator, there can be suitably enumerated benzoyl peroxide; peroxide compounds as described in U.S. Pat. No. 4,950,581 (column 19, lines 17 to 25), such as peroxides; aromatic sulfonium or iodonium salts as described in U.S. Pat. No. 4,950,581 (column 18, line 60 to column 19, line 10); and cyclopentadienyl-arene iron(II) complex salts such as (η⁶-isopropylbenzene)-(η⁵-cyclopentadienyl)-iron(II) hexafluorophosphate.

In addition, examples of the dye/boron compound which may be suitably used include compounds as described in JP-A-62-143044, JP-A-1-138204, JP-T-6-505287, and JP-A-4-261406.

As the spectral sensitizing compound having a maximum absorption wavelength at from 300 to 1,000 nm, spectral sensitizing dyes having a maximum absorption wavelength in this wavelength region may be used. By selecting a desired arbitrary dye among the foregoing spectral sensitizing dyes having a maximum absorption wavelength in such a wavelength region and adjusting the photosensitive wavelength so as to adapt to a light source which is used for the irradiation with light for applying the color information, high sensitivity can be obtained.

The spectral sensitizing dye can be properly selected among known compounds, and examples thereof include those as described in Research Disclosure, Vol. 200, December 1980, Item 20036 and Zokanzai (Sensitizers) (pages 160 to 163, published by Kodansha Ltd. and edited by Katsuya Tokumaru and Makoto Okawara, 1987).

Specific examples thereof include 3-ketocourmarin compounds as described in JP-A-58-15603; thiopyrylium compounds as described in JP-A-58-40302; naphthothiazole merocyanine compounds as described in JP-B-59-28328 and JP-B-60-53300; and merocyanine compounds as described in JP-B-61-9621, JP-B-62-3842, JP-A-59-89303, and JP-A-60-60104.

Furthermore, there can be enumerated dyes as described in Kinosei Shikiso no Kagaku (Chemistry of Functional Dyes) (pages 393 to 416, 1981, published by CMC Publishing Co., Ltd.) and Shikizai (Color Materials) (60 [4], 212-224 (1987)). Specific examples thereof include cationic methine dyes, cationic carbonium dyes, cationic quinoimine dyes, cationic indoline dyes, and cationic styryl dyes.

The spectral sensitizing dye includes keto dyes such as coumarin (inclusive of ketocoumarin or sulfonocoumarin) dyes, merostyryl dyes, oxonol dyes, and hemiooxonol dyes; non-keto dyes such as non-keto polymethine dyes, triarylmethane dyes, xanthene dyes, anthracene dyes, rhodamine dyes, acridine dyes, aniline dyes, and azo dyes; non-keto polymethine dyes such as azomethine dyes, cyanine dyes, carbocyanine dyes, dicarbocyanine dyes, tricarbocyanine dyes, hemicyanine dyes, and styryl dyes; and quinoneimine dyes such as azine dyes, oxazine dyes, thiazine dyes, quinoline dyes, and thiazole dyes.

By properly using the spectral sensitizing dye, it is possible to obtain the spectral sensitivity of the photopolymerization initiator which is used for the toner in from ultraviolet to infrared regions. Furthermore, the foregoing spectral sensitizing dye may be used singly or in combination of two or more kinds thereof.

For example, in the case where the toner according to an aspect of the invention has a structure as exemplified in FIGS. 6 to 9, the use amount of the spectral sensitizing compound may be suitably from 0.1 to 5% by mass, and more suitably from 0.5 to 2% by mass based on the total weight of the materials which configure the photosensitive or thermosensitive capsule (or the photosensitive or thermosensitive layer). The same is applicable to the case where the toner according to an aspect of the invention has a structure containing only one color developing part.

As the compound capable of mutually acting with the spectral sensitizing compound, one or two or more compounds can be properly selected and used among known compounds capable of initiating a photopolymerization reaction with the photopolymerizable group in the second component.

By making this compound copresent together with the foregoing spectral sensitizing compound, it is possible to generate a radical which is excessively sensitive to the irradiation light in its spectral absorption wavelength region in a high efficiency. Thus, it is possible to design to realize high sensitization and to control the generation of a radical using an arbitrary light source in from ultraviolet to infrared regions.

As the foregoing “compound capable of mutually acting with the spectral sensitizing compound”, organic borate salt compounds, benzoin ethers, trihalogen-substituted methyl group-containing s-triazine derivatives, organic peroxides, and azinium salt compound may be suitable, and organic borate salt compounds may be more suitable. By using this “compound capable of mutually acting with the spectral sensitizing compound” together with the foregoing spectral sensitizing compound, it is possible to generate a radical in an exposed area locally and effectively and to attain high sensitization.

Examples of the organic borate salt compound include organic borate compounds as described in JP-A-62-143044, JP-A-9-188685, JP-A-9-188686, and JP-A-9-188710 (hereinafter sometimes referred to as “borate compound I”); and spectral sensitizing dye based borate compounds obtainable from cationic dyes as described in Kinosei Shikiso no Kagaku (Chemistry of Functional Dyes) (pages 393 to 416, 1981, published by CMC Publishing Co., Ltd.) and Shikizai (Color Materials) (60 [4], 212-224 (1987)) (hereinafter sometimes referred to as “borate compound II”).

This borate compound II is a compound containing both a dye segment and a borate segment within its structure and has three functions of absorbing light source energy more effectively by the light absorption function of the dye segment at the time of exposure, promoting the polymerization reaction by the radical release function of the borate segment and simultaneously decoloring the coexisting spectral sensitizing compound.

Concretely, all cationic dyes can be suitably used so far as they have a maximum absorption wavelength in a wavelength region of 300 nm or more, and preferably in a wavelength region of from 400 to 1,100 nm. Above all, cationic methine dyes, polymethine dyes, triarylmethane dyes, indoline dyes, azine dyes, xanthene dyes, cyanine dyes, hemicyanine dyes, rhodamine dyes, azamethine dyes, oxazine dyes, and acridine dyes are suitable; and cationic cyanine dyes, hemicyanine dyes, rhodamine dyes, and azamethine dyes are more suitable.

The borate compound II obtainable from the foregoing organic cationic dye can be obtained by using an organic cationic dye and an organic boron compound anion while referring to a method as described in European Patent No. 223,587A1.

As described previously, though the borate compound II is a polyfunctional compound, from the viewpoint of obtaining high sensitivity and sufficient decoloring properties, it is desirable according to an aspect of the invention that the photopolymerization initiator is configured to properly combine a spectral sensitizing compound and a compound capable of mutually acting with the spectral sensitizing compound. In this case, the photopolymerization initiator is more desirable (1) a photopolymerization initiator which is a combination of the spectral sensitizing compound and the borate compound I or (2) a photopolymerization initiator which is a combination of the borate compound I and the borate compound II.

At this time, a use ratio of the spectral sensitizing dye to the organic borate compound present in the photopolymerization initiator is very useful in view of obtaining high sensitivity and sufficient decoloring properties due to light irradiation in a light irradiation step which is carried out as the need arises after the color development by a heat treatment at the time of fixation during the image formation (for example, deactivation and decomposition of an unreacted reactive substance).

In the case of the photopolymerization initiator (1), in the photopolymerization initiator, in addition to a ratio of the spectral sensitizing compound to the borate compound I necessary for the photopolymerization reaction (=1/1 by mole), the addition of the borate compound I in an amount necessary for sufficiently decoloring the spectral sensitizing compound that remains in the toner is especially desirable from the standpoint of obtaining high sensitivity and decoloring performance.

That is, the ratio of the spectral sensitizing dye to the borate compound I may be suitably in the range of from 1/1 to 1/50, more suitably in the range of from 1/1.2 to 1/30, and most suitably in the range of from 1/1.2 to 1/20. When the foregoing ratio is less than 1/1, sufficient polymerization reactivity and decoloring properties cannot be obtained, whereas it exceeds 1/50, the formation of a photosensitive or thermosensitive capsule (or a photosensitive or thermosensitive layer) may possibly become difficult, and therefore, such is not preferable.

Furthermore, in the case of the photopolymerization initiator (2), it is especially desirable from the standpoint of obtaining sufficient high sensitivity and decoloring performance to use a combination of the borate compound I and the borate compound II such that a ratio of the borate site to the dye site is equimolar or more. The ratio of the borate compound I to the borate compound II is preferably in the range of from 1/1 to 50/1, more preferably in the range of from 1.2/1 to 30/1, and most preferably in the range of from 1.2/1 to 20/1. When the ratio of the borate compound I to the borate compound II is less than 1/1, the generation of a radical is small and sufficient polymerization reactivity and decoloring performance are not obtained, whereas when it exceeds 50/1, sufficient sensitivity is not obtained, and therefore, such is not preferable.

The total amount of the spectral sensitizing dye and the organic borate compound in the photopolymerization initiator may be suitably in the range of from 0.1 to 10% by mass, more suitably in the range of from 0.1 to 5% by mass, and most suitably in the range of from 0.1 to 1% by mass based on the use amount of the photopolymerizable group-containing compound (second component). When the use amount of the spectral sensitizing dye and the organic borate compound is less than 0.1% by mass, the effect according to an aspect of the invention cannot be obtained, whereas when it exceeds 10% by mass, not only the storage stability of the toner may possibly be lowered but also the formation of a photosensitive or thermosensitive capsule (or a photosensitive or thermosensitive layer) may possibly become difficult.

### —Auxiliary—

Furthermore, for the purpose of promoting the polymerization reaction, a reducing agent such as oxygen scavengers and chain transfer agents of an active hydrogen donor or other compound for promoting the polymerization in a chain transfer manner can be further added as an auxiliary in the photocurable composition.

Examples of the oxygen scavenger include phosphines, phosphonates, phosphites, primary silver salts, and other compounds which are readily oxidized by oxygen. Specific examples thereof include N-phenylglycine, trimethyl-barbituric acid, N,N-dimethyl-2,6-diisopropylaniline, and N,N,N-2,4,6-pentamethylaniline. In addition, thiols, thioketones, trihalomethyl compounds, lophine dimer compounds, iodonium salts, sulfonium salts, azinium salts, organic peroxides, azides, and so on are also useful as the polymerization promoter.

### (Microencapsulation)

According to an aspect of the invention, the first component such as the electron donating colorless dye and the diazonium salt compound is encapsulated in a capsule and used.

As the microencapsulation method, methods which have hitherto been known can be employed. Examples thereof include a method utilizing coacervation of a hydrophilic wall forming material as described in U.S. Pat. Nos. 2,800,457 and 2,800,458; an interfacial polymerization method as described in U.S. Pat. No. 3,287,154, U.K. Patent No. 990,443, JP-B-38-19574, JP-B-42-446, and JP-B-42-771; a method by polymer deposition as described in U.S. Pat. Nos. 3,418,250 and 3,660,304; a method using an isocyanate polyol wall material as described in U.S. Pat. No. 3,796,669; a method using an isocyanate wall material as described in U.S. Pat. No. 3,914,511; a method using a urea-formaldehyde based or urea-formaldehyde-resorcinol based wall forming material as described in U.S. Pat. Nos. 4,001,140, 4,087,376 and 4,089,802; a method using a wall forming material such as a melamine-formaldehyde resin and hydroxypropyl cellulose as described in U.S. Pat. No. 4,025,455; an in situ method by monomer polymerization as described in JP-B-36-9168 and JP-A-51-9079; an electrolytic dispersion cooling method as described in U.K. Patent Nos. 952,807 and 965,074; a spray driving method as described in U.S. Pat. No. 3,111,407 and U.K. Patent No. 930,422; and methods as described in JP-B-7-73069, JP-A-4-101885, and JP-A-9-263057.

The microencapsulation method is not limited to these methods. However, according to an aspect of the invention, an interfacial polymerization method in which an oil phase as prepared by dissolving or dispersing the first component in a hydrophobic organic solvent which becomes a core part of the capsule is mixed with an aqueous phase having a water-soluble polymer dissolved therein, the mixture is emulsified and dispersed by means of a homogenizer or the like, and the resulting emulsified dispersion is then heated to cause a polymer forming reaction at the oil droplet interface, thereby forming a microcapsule wall made of a polymer substance may especially desirably employed. According to the interfacial polymerization method, a capsule having a uniform particle size can be formed within a short period of time, and a toner having suitable unprocessed stock storability can be obtained.

According to an aspect of the invention, a desirable microcapsule is a microcapsule in which the contact between substances inside and outside the capsule is hindered by a substance isolating action of the microcapsule wall (outer shell) at the ordinary temperature and only when heat and/or pressure is applied in a certain value or more, the contact between the substances inside and outside the capsule becomes possible. This phenomenon can be freely controlled as a change in physical properties of the capsule by properly selecting a material of the microcapsule wall, a substance which is contained in the core part of the microcapsule, additives, and so on.

The material of the microcapsule wall which can be used according to an aspect of the invention is added in the interior of an oil droplet and/or the exterior of an oil droplet. Examples of the material of the microcapsule wall include polyurethanes, polyureas, polyamides, polyesters, polycarbonates, urea-formaldehyde resins, melamine resins, polystyrenes, styrene-methacrylate copolymers, and styrene-acrylate copolymers. Of these, polyurethanes, polyureas, polyamides, polyesters, and polycarbonates are desirable; and polyurethanes and polyureas are more desirable. The polymer substance can also be used in admixture of two or more kinds thereof.

For example, all of the containing components including the first component can be solid dispersed together with a water-soluble polymer, a sensitizer and other color development auxiliary by means of a sand mill or the like. However, it may be suitable to use them as an emulsified dispersion as prepared by previously dissolving the components in a sparingly water-soluble or water-insoluble high boiling organic solvent, mixing the solution with a polymer aqueous solution (aqueous phase) containing a surfactant and/or a water-soluble polymer as a protective colloid, and emulsifying the mixture by a homogenizer or the like. In this case, if desired, a low boiling solvent can be used as a dissolution auxiliary. In addition, all of the containing components including the first component can also be separately emulsified and dispersed; or can be dissolved in a high boiling solvent and/or a low boiling solvent after previously mixing and then emulsified and dispersed. The emulsified dispersion as formed by emulsification and dispersion may suitably have a particle size of not more than 1 μm.

After the emulsification, for the purpose of promoting the microcapsule wall forming reaction, the emulsion is heated at from 30 to 70° C. Furthermore, in order to prevent coagulation among the capsules during the reaction, it is necessary to lower a collision probability among the capsules by adding water or to carry out thorough stirring. On the other hand, a dispersion for preventing coagulation can also be added during the reaction. With respect to the end point of the microcapsule wall forming reaction, when the generation of carbon dioxide accompanying the progress of the polymerization reaction is observed, the cessation thereof can be considered to be approximately the end point. Usually, by carrying out the reaction for several hours, a microcapsule having the first component encapsulated therein can be obtained.

The microcapsule may be suitably adjusted so as to have a volume average particle size in the range of from 0.1 to 3.0 μm, and more suitably in the range of from 0.3 to 1.0 μm.

Furthermore, in the case where the toner has a structure as exemplified in FIGS. 6 to 9, the photosensitive or thermosensitive capsule (or the photosensitive or thermosensitive layer) may contain a binder. The same is applicable to the case where the toner has a structure containing only one color developing part.

As the binder, besides the same binders as the binder which is used for emulsifying and dispersing the foregoing photocurable composition and water-soluble polymers which are used in encapsulating the first reactive substance, there can be used solvent-soluble polymers such as acrylic resins, phenol resins, styrene-butadiene resins, ethyl cellulose, epoxy resins, and urethane resins (for example, polystyrenes, polyvinyl formal, polyvinyl butyral, polymethyl acrylate, polybutyl acrylate, polymethyl methacrylate, polybutyl methacrylate, and copolymers thereof) and polymer latexes thereof. Above all, gelatin and polyvinyl alcohol are suitable. Furthermore, a binding resin as described later may be used as the binder.

In addition, additives such as dyes, ultraviolet light absorbers, plasticizers, fluorescent brighteners, curing agent, and antistatic agents can also be used as the need arises. Specific examples of the additives are described in Research Disclosure, Vol. 176, Item 17643 (December 1978) and ibid., Vol. 187, Item 18716 (November 1979).

### —Curing Agent—

In the toner according to an aspect of the invention having a structure as exemplified in FIGS. 6 to 9, a curing agent can also be used jointly in each of the photosensitive or thermosensitive capsule (or the photosensitive or thermosensitive layer), an interlayer, and so on.

As the curing agent, a “gelatin curing agent” which is used in the manufacture of a photographic light-sensitive material is useful. Examples thereof include aldehyde based compounds (for example, formaldehyde and glutaldehyde); reactive halides as described in U.S. Pat. No. 3,635,718; reactive ethylenically unsaturated group-containing compounds as described in U.S. Pat. No. 3,635,718; arizine based compounds as described in U.S. Pat. No. 3,017,280; epoxy based compounds as described in U.S. Pat. No. 3,091,537; halogenocarboxyaldehydes such as mucochloric acid; dixoanes such as dihydroxydioxane and dichlorodioxane; vinylsulfones as described in U.S. Pat. Nos. 3,642,486 and 3,687,707; vinylsulfone precursors as described in U.S. Pat. No. 3,841,872; and ketovinyls as described in U.S. Pat. No. 3,640,720. Furthermore, chromium alum, zirconium sulfate, boric acid, and so on can be used as an inorganic curing agent, too.

### —Binding Resin—

In the toner according to an aspect of the invention, binding resins which are used in conventional toners can be used. For example, in the toner having a structure as exemplified in FIG. 6 in which a photosensitive or thermosensitive capsule is dispersed in a matrix, the binding resin can be utilized as the major component which configures the matrix or a material which configures an outer shell of the photosensitive or thermosensitive capsule; and in the toner having a structure containing two or more color developing parts in a stratiform state as exemplified in FIGS. 7 to 9 (for example, a concentric circle structure, a stripe structure, and a folding fan structure), the binding resin can be utilized as a material which configures a coating layer for coating the outermost surface of the toner or an interlayer to be provided between the adjacent two color developing parts. However, it should not be construed that the invention is limited thereto.

The binding resin is not particularly limited, and known crystalline or amorphous resin materials can be used. In particular, for the purpose of applying low-temperature fixability, a crystalline polyester resin having sharp melting properties is useful.

The crystalline resin may suitably have a melting point of from 50 to 110° C., and more suitably from 60 to 90° C. When the melting point is lower than 50° C., the storability of the toner or the storability of the toner image after fixing may possibly become problematic, whereas when it is higher than 110° C., sufficient low-temperature fixation may not be possibly obtained as compared with conventional toners.

Furthermore, there may be the case where the crystalline resin exhibits plural melting peaks. According to an aspect of the invention, its maximum peak is defined as the melting point.

Furthermore, as the amorphous polymer (amorphous resin), known resin material such as styrene-acrylic resins and polyester resins can be used. Above all, amorphous polyester resins are especially desirable. The “amorphous polyester resin” which is used according to an aspect of the invention is obtained by polycondensation of mainly a polyhydric carboxylic acid and a polyhydric alcohol.

Use of an amorphous polyester resin is desirable in view of the point that a resin particle dispersion can be readily prepared by adjusting an acid value of the resin or emulsifying and dispersing while using an ionic surfactant, etc.

The amorphous polymer which can be used for the toner may suitably have a weight average molecular weight (Mw) of from 5,000 to 1,000,000, and more suitably from 7,000 to 500,000 and a number average molecular weigh (Mn) of from 2,000 to 10,000, with molecular weight distribution Mw/Mn being suitably from 1.5 to 100, and more suitably from 2 to 60, according to a molecular weight measurement regarding a matter which is soluble in tetrahydrofuran (THF) by the gel permeation chromatography (GPC).

A glass transition temperature of the amorphous polymer which can be used according to an aspect of the invention may be suitably from 35 to 100° C., and more suitably from 50 to 80° C. in view of the balance between storage stability and fixability of the toner. When the glass transition temperature is lower than 35° C., blocking (a phenomenon that toner particles are coagulated to form a block) is liable to occur during the storage or development of the toner. On the other hand, when the glass transition temperature exceeds 100° C., the fixing temperature of the toner become high, and therefore, such is not preferable.

Furthermore, a softening point of the amorphous polymer may be suitably present in the range of from 80 to 130° C., and more suitably from 90 to 120° C. In the case where the softening point is lower than 80° C., the stability of the toner and the stability of the toner image are remarkably deteriorated after fixing and during the storage. On the other hand, in the case where the softening point exceeds 130° C., the low-temperature fixability is remarkably deteriorated.

The measurement of the softening point of the amorphous polymer is carried out by using a flow tester (manufactured by Shimadzu Corporation, CFT-500C) under conditions (preheating: 80° C./300 sec, plunger pressure: 0.980665 MPa, die size: 1 mmφ×1 mm, temperature rise rate: 3.0° C./min), and an intermediate temperature between the melting start temperature and the melting end temperature is defined as the softening point.

### —Surface Lubricant—

The toner according to an aspect of the invention can contain a surface lubricant. The surface lubricant is generally used for the purpose of improving surface lubricating properties.

The surface lubricant which can be used for the toner is not particularly limited. Examples thereof include mineral waxes, petroleum waxes, natural gas based waxes, and modification products thereof (for example, montan wax, ozokerite, ceresin, paraffin wax, microcrystalline wax, microstalline wax, and Fischer-Tropsch wax); low molecular weight polyolefins (for example, polyethylene, polypropylene, and polybutene); silicones exhibiting a softening point by heating; fatty acid amides (for example, oleic amide, erucic amide, recinoleic amide, and stearic amide); vegetable waxes (for example, carnauba wax, rice wax, candelilla wax, Japan wax, and jojoba wax); and animal waxes (for example, bees wax). Furthermore, as a modification auxiliary component, higher alcohols having from 10 to 18 carbon atoms and mixtures thereof; and higher fatty acid monoglycerides having from 16 to 22 carbon atoms and mixtures thereof can be enumerated. A combination selected therefrom can be used.

### —Other Additives—

The toner according to an aspect of the invention may contain other components than those as enumerated previously. These other components are not particularly limited but can be properly selected corresponding to the purpose. Examples thereof include various known additives which are used in conventional toners, such as inorganic fine particles, organic particles, and charge control agents. Furthermore, since the toner according to an aspect of the invention causes color development by itself, a coloring agent which is used in conventional toners, such as pigments, is not basically necessary. However, for the purpose of finely adjusting the color tone at the time of color development, a small amount of a known coloring agent can be used as the need arises.

The charge control agent is used for the purpose of more improving and stabilizing charge properties. As the charge control agent, there can be used various charge control agents which are usually used, such as quaternary ammonium salt compounds, nigrosine based compounds, dyes made of an aluminum, iron or chromium complex, and triphenylmethane based pigments. However, in the case of preparing a toner by an emulsion aggregation method as described later, a material which is hardly soluble in water may be suitable from the standpoints of controlling the ionic strength which influences the stability of an aggregated particle as formed in a solution and reducing the waste liquor contamination.

Furthermore, for the purposes of applying fluidity and improving cleaning properties, likewise the case of a conventional toner, after drying, an inorganic particle such as silica, alumina, titania, and calcium carbonate or a resin particle such as vinyl based resins, polyesters, and silicones can be added as a fluidity auxiliary or a cleaning auxiliary onto the toner surface while applying a shear in a dry state.

### (Toner Configuring Materials of Light Color Development Type Toner and so on)

Next, in the case where the toner according to an aspect of the invention is a light color development type toner, the toner configuring materials which are used and materials, methods and so on which are used in adjusting the respective toner configuring materials will be hereunder described in more detail.

In this case, in the toner, at least the first component, the second component, the microcapsule containing the first component, and the photocurable composition containing the second component and the photopolymerizable compound are used, and it may be especially suitable that the photopolymerization initiator (or the photopolymerization initiator system) is contained in the photocurable composition. A spectral sensitizing dye or various auxiliaries may also be contained. Furthermore, although the first component may be present in a solid state within the microcapsule (core part), it may also be present together with a solvent.

Incidentally, in the light color development type toner, an electron donating colorless dye is used as the first component; an electron accepting compound (hereinafter sometimes referred to as “electron accepting developer” or “developer”) is used as the second component; and in the case of the first light color development type toner, an ethylenically unsaturated bond-containing polymerizable compound is used as the photopolymerizable compound. The electron donating colorless dye as the first component, the spectral sensitizing dye and the configuring materials such as various auxiliaries and the microencapsulation method are the same as those as described previously in the light non-color development type toner.

Furthermore, in addition to the foregoing enumerated materials, the matter that the same various materials as those which configure a conventional toner using a coloring agent, a binding resin, a surface lubricant, an internal additive, an external additive, and so on can be properly utilized as the need arises is the same as in the foregoing light non-color development type toner.

### —Ethylenically Unsaturated Bond-Containing Polymerizable Compound (Photopolymerizable Compound)—

The ethylenically unsaturated bond-containing polymerizable compound which can be used according to an aspect of the invention is a polymerizable compound containing at least one ethylenically unsaturated double bond in the molecule thereof.

Examples of the ethylenically unsaturated bond-containing polymerizable compound which can be used include acrylic acid and salts thereof, acrylic esters, acrylamides, methacrylic acid and salts thereof, methacrylic esters, methacrylamides, maleic anhydride, maleic esters, itaconic acid, itaconic esters, styrenes, vinyl ethers, vinyl esters, N-vinyl heterocyclic compounds, aryl ethers, and allyl esters. Of these, polymerizable compounds containing a hetero atom having at least one lone pair of electrons within the molecule thereof are suitable.

The “hetero atom containing a lone pair of electrons” as referred to herein means an atom such as oxygen, nitrogen, sulfur, phosphorus, and halogens. Specific examples of the polymerizable compound include polymerizable compounds containing an ester bond, an amide bond, a carbonyl bond, a thiocarbonyl bond, an ether bond, a thioether bond, or a group such as amines, alcohols, thioalcohols, phosphines, and halogens. Of these, ethylenically unsaturated bond-containing polymerizable compounds containing at least one of an ester bond, an amide bond, an amine, a carbonyl bond and/or an ether bond, each of which has a strong mutual action with the electron accepting developer, within the molecule thereof are desirable; and photopolymerizable compounds containing an ester bond or an amide bond are especially desirable.

Furthermore, in order to make polymerization efficiency (curing rate) improve, polymerizable compounds containing plural ethylenically unsaturated double bonds in the molecule are desirable. Examples thereof include acrylic esters or methacrylic esters of a polyhydric alcohol such as trimethylolpropane and pentaerythritol; and acrylate- or methacrylate-terminated epoxy resins and acrylate- or methacrylate-terminated polyesters.

### —Photopolymerization Initiator (or Photopolymerization Initiator System)—

As the photopolymerization initiator which is suitably used according to an aspect of the invention, one kind or a combination of two or more kinds of compounds can be selected among compounds capable of initiating photopolymerization of the foregoing ethylenically unsaturated bond-containing compound.

Specific examples of the photopolymerization initiator which may be suitably used include the following compounds. That is, there can be usefully used photopolymerization initiators which are well-known in the photosensitive or thermosensitive recording material field, such as aromatic ketones, for example, benzophenone, 4,4′-bis(dimethylamino)benzophenone, 4-methoxy-4′-dimethylaminobenzophenone, 4,4′-dimethoxybenzophenone, 4-dimethylaminobenzophenone, 4-dimethylaminoacetophenone, benzil, anthraquinone, 2-tert-butylanthraquinone, 2-methylanthraquinone, xanthone, thioxanthone, 2-chlorothioxanthone, 2,4-diethylthioxanthone, fluororenone, and acridone; benzoin and benzoin ethers, for example, benzoin methyl ether, benzoin ethyl ether, benzoin isopropyl ether, and benzoin phenyl ether; 2,4,5-triaryl-imidazole dimers, for example, 2-(o-chlorophenyl)-4,5-di-phenylimidazole dimer, 2-(o-chlorophenyl)-4,5-di(m-methoxyphenyl)imidazole dimer, 2-(o-fluorophenyl)-4,5-di-phenylimidazole dimer, 2-(o-methoxyphenyl)-4,5-diphenyl-imidazole dimer, and 2-(p-methoxyphenyl)-4,5-diphenylimidazole dimer; polyhalogen compounds, for example, carbon tetraboride, phenyltribromomethylsulfone, phenyl trichloromethyl ketone, compounds as described in JP-A-53-133428, JP-B-57-1819, JP-B-57-6096, and U.S. Pat. No. 3,615,455, and trihalogen-substituted methyl group-containing s-triazine derivatives as described in JP-A-58-29803, for example, compounds such as 2,4,6-tris(trichloromethyl)-s-triazine, 2-methoxy-4,6-bis(trichloromethyl)-s-triazine, 2-amino-4,6-bis(trichloromethyl)-s-triazine, and 2-(p-methoxystyryl)-4,6-bis(trichloromethyl)-s-triazine; organic peroxides as described in JP-A-59-189340, for example, compounds such as methyl ethyl ketone peroxide, cyclohexanone peroxide, 3,3,5-trimethylcyclohexanone peroxide, benzoyl peroxide, di-tert-butyl diperoxyisophthalate, 2,5-dimethyl-2,5-di-(benzoylperoxy)hexane, tert-butyl peroxybenzoate, α,α′-bis(tert-butyl peroxyisopropyl)benzene, dicumyl peroxide, and 3,3′,4,4′-tetra(tert-butyl peroxycarbonyl)-benzophenone; azinium salt compounds as described in U.S. Pat. No. 4,743,530; organic boron compounds as described in European Patent No. 0223587, for example, a tetra-methylammonium salt of triphenylbutyl borate, a tetra-butylammonium salt of triphenylbutyl borate, and a tetra-methylammonium salt of tri(p-methoxyphenyl)butyl borate; and besides, diaryl iodonium salts and iron-arene complexes.

The content of the photopolymerization initiator may be suitably from 0.01 to 20% by mass, more suitably from 0.2 to 15% by mass, and most suitably from 1 to 10% by mass based on the total weight of the photocurable composition. When the content of the photopolymerization initiator is less than 0.01% by mass, the sensitivity may possibly be insufficient, whereas even when it exceeds 10% by mass, an increase of the sensitive may not be possibly expected.

### —Electron Accepting Developer (Second Component)—

Examples of the electron accepting developer include phenol derivatives, sulfur-containing phenol derivatives, organic carboxylic acid derivatives (for example, salicylic acid, stearic acid, and recorcylic acid) and metal salts thereof, sulfonic acid derivatives, urea or thiourea derivatives, acid clay, bentonite, novolak resins, metal-treated novolak resins, and metal complexes.

These examples are described in JP-B-40-9309, JP-B-45-14039, JP-A-52-140483, JP-A-48-51510, JP-A-57-210886, JP-A-58-87089, JP-A-59-11286, JP-A-60-176795, and JP-A-61-95988 in addition to Japanese Journal of Paper Technology (1985), pages 49 to 54 and pages 65 to 70.

Such an electron accepting compound can be used singly or in combination of two or more kinds thereof. The use amount of the electron accepting compound may suitably range from 10 to 4,000% by mass, and especially suitably from 100 to 2,000% by mass based on the electron donating colorless dye.

In addition, besides these compounds, a heat polymerization inhibitor can be added in the photocurable composition as the need arises. The heat polymerization inhibitor is added for the purpose of preventing thermal polymerization or polymerization with time of the photocurable composition, and by using this heat polymerization inhibitor, the chemical stability of the photocurable composition at the time of preparation or storage can be enhanced. Examples of the heat polymerization inhibitor include p-methoxyphenol, hydro-quinone, t-butylcatechol, pyrogallol, 2-hydroxy-benzophenone, 4-methoxy-2-hydroxybenzophenone, cuprous chloride, phenothiazine, chloranil, naphthylamine, β-naphthol, 2,6-di-t-butyl-p-cresol, nitrobenzene, dinitro-benzene, picric acid, and p-toluidine. The suitable addition amount of the heat polymerization inhibitor may be suitably from 0.001 to 5% by mass, and more suitably from 0.01 to 1% by mass based on the total weight of the photocurable composition. When the addition of the heat polymerization inhibitor is less than 0.001% by mass, the heat stability is deteriorated, whereas when it exceeds 5% by mass, the sensitivity is lowered.

Incidentally, if desired, the photocurable composition may be encapsulated in a microcapsule and used. For example, the encapsulation can be achieved by referring to European Patent No. 0223587 and the foregoing patents.

As in the case of the light color development type toner, the volume average particle size of the microcapsule may be suitably adjusted within the range of from 0.1 to 3 μm, and more suitably within the range of from 0.3 to 1.0 μm.

In addition, the electron donating colorless dye may be in a solution state or a solid state in the microcapsule. In the case of using a solvent jointly, the amount of the solvent which is jointly used within the capsule may be suitably in a proportion of from 1 to 500 parts by mass based on 100 parts by mass of the electron donating colorless dye.

Furthermore, for the purpose of improving the light fastness of the image or the like, an ultraviolet absorber can be used in the toner according to an aspect of the invention as the need arises. As the ultraviolet absorber, there can be used known compounds in the art, such as benzotriazole based compounds, cinnamic ester based compounds, aminoallylidene malonitrile based compounds, and benzophenol based compounds.

In the case where the toner according to an aspect of the invention is prepared by a wet preparation method such as an emulsion aggregation method as described later, a dispersion having the microcapsule dispersed therein or a dispersion having the photocurable composition dispersed therein is prepared. Example of a solvent which is used for preparing such a dispersion include water, alcohols (for example, methanol, ethanol, n-propanol, isopropanol, n-butanol, sec-butanol, methyl cellosolve, and 1-methoxy-2-propanol), halogen based solvents (for example, methylene chloride and ethylene chloride), ketones (for example, acetone, cyclohexanone, and methyl ethyl ketone), esters (for example, methyl cellosolve acetate, ethyl acetate, and methyl acetate), toluene, and xylene. The solvent can be used singly or in admixture of two or more kinds thereof. Of these, water is especially desirable.

### —Others—

Besides the foregoing materials, with respect to a binding resin, a surface lubricant and other additives which are used in the light color development type toner, the same materials as those in the light non-color development type toner as already described can be used. The particle size and shape and so on of the toner are also the same as in the light non-color development type toner.

Furthermore, so far as the color development characteristics and color development control are not adversely affected, the materials and so on as enumerated for the light color development type toner may be used for the light non-color development type toner, and the materials and so on as enumerated for the light non-color development type toner may be used for the light color development type toner.

### (Toner Production Process)

Next, the toner production process will be specifically descried below.

The toner which is used according to an aspect of the invention may be suitably prepared by utilizing a known wet preparation method such as an emulsion aggregation method. The wet preparation method may be especially suitable in the case where the toner has a configuration of undergoing color development utilizing at least material diffusion at the time of heating (for example, the case where the already mentioned two or more kinds of reactive components are contained in a different matrix). Furthermore, by utilizing the wet preparation method, a maximum process temperature in the case of preparing a toner can be controlled at a low level so that it is easy to prevent the color development in the toner production process.

Incidentally, from the viewpoint of preventing the color development in the toner production process, the maximum process temperature in the case of utilizing a wet preparation method may be suitably not higher than 90° C., and more suitably not higher than 80° C. However, in the case where the process temperature is too low, since the preparation of a toner itself becomes difficult, the maximum process temperature may be suitably 40° C. or higher.

Furthermore, the utilization of the wet preparation method is especially suitable for preparing a toner having a structure in which the first component and the second component which are color developed in the mutual reaction therebetween, the photocurable composition and the micro-capsule which is dispersed in the photocurable composition are contained, the first component is contained in the microcapsule, and the second component is contained in the photocurable composition.

Incidentally, though the microcapsule which is used for the toner having the foregoing structure may be especially suitably a heat responsible microcapsule, it may be a microcapsule which responds to light or other stimulus.

For the production of a toner, though known wet preparation methods can be utilized, it may be especially suitable to utilize an emulsion aggregation method among the wet preparation methods because not only the maximum process temperature can be controlled at a low level, but also the preparation of toners having various structures as exemplified in FIGS. 6 and 7 and the like is easy.

Furthermore, as compared with conventional toners containing, as the major components, a pigment and a binding resin, since a toner having the foregoing structure contains a large amount of the photocurable composition containing, as the major component, a low molecular weight component, the strength of a particle as obtained in the granulation process of the toner is liable to become insufficient. However, according to the emulsion aggregation method, since a high shear force is not required, it may be suitable to utilize the emulsion aggregation method in this point, too.

Next, the production process of the toner utilizing an emulsion aggregation method will be hereunder described in more detail. In general, the emulsion aggregation method includes, after preparing dispersions of various materials which configure the toner, an aggregation step for forming an aggregated particle in a raw material dispersion having two or more kinds of dispersions mixed therein; and a fusion step for fusing the aggregated particle as formed in the raw material dispersion. If desired, an attachment step (coating layer forming step) for forming a coating layer by attaching a component capable of forming a coating layer on a surface of the aggregated particle is carried out between the aggregation step and the fusion step.

In the production of a toner which is used according to an aspect of the invention, though the kinds of various dispersions to be used as raw materials and a combination thereof are different, the toner can be prepared by properly combining an attachment step, if desired, in addition to an aggregation step and a fusion step.

The production process of a toner having a color developing part-dispersed structure as exemplified in FIG. 6 or a toner having a concentric circle structure as exemplified in FIG. 7 by utilizing an emulsion aggregation method will be hereunder described in more detail.

### A. Production Process of Toner Having Color Developing Part-Dispersed Structure:

First of all, a production process of a toner having a color developing part-dispersed structure utilizing an emulsion aggregation method will be described below.

In this case, first of all, at least one kind of a photosensitive or thermosensitive capsule dispersion which is able to be color developed in a color different from each other is prepared by going through (a1) a first aggregation step for forming a first aggregated particle in a raw material dispersion containing a microcapsule dispersion having a first component-containing microcapsule dispersed therein and a photocurable composition dispersion having a second component-containing photocurable composition dispersed therein; (b1) an attachment step for adding a first resin particle dispersion having a resin particle dispersed therein to the raw material dispersion having the first aggregated particle formed therein, thereby attaching the resin particle onto the aggregated particle surface; and (c1) a first fusion step for heating the raw material dispersion containing the aggregated particle onto the surface of which the resin particle is attached to cause fusion, thereby obtaining a first fused particle (photosensitive or thermosensitive capsule).

Subsequently, by going through (d1) a second aggregation step for forming a second aggregated particle in a mixed solution which is a mixture of the foregoing at least one kind of the photosensitive or thermosensitive capsule dispersion and a second resin particle dispersion having a resin particle dispersed therein; and (e1) a second fusion step for heating the second aggregated particle-containing mixed solution to obtain a second fused particle, a toner having a color developing part-dispersed structure can be obtained.

Incidentally, with respect to the kind of the photo-sensitive or thermosensitive capsule dispersion which is used in the second aggregation step, a combination of two or more kinds thereof may be suitable. Furthermore, the photosensitive or thermosensitive capsule as obtained through the (a1) to (c1) steps may be utilized as a toner (namely, a toner containing only one color developing part) as it stands.

### —Preparation of Various Kinds of Dispersions—

The preparation method of various kinds of dispersions which are used in the toner production process utilizing the foregoing emulsion aggregation method will be hereunder described.

The resin particle dispersion is prepared by dispersing a resin particle as prepared by emulsion polymerization or the like in a solvent by using an ionic surfactant. Alternatively, the resin particle dispersion is prepared by dissolving the resin particle in a solvent capable of dissolving the resin therein, followed by phase inversion emulsification. Incidentally, examples of a dispersion medium in the resin particle dispersion include aqueous media and organic solvents.

Furthermore, the surface lubricant dispersion is prepared by dispersing a surface lubricant in water together with an ionic surfactant or a high molecular weight electrolyte (for example, high molecular weight acids and high molecular weight bases) and heating the dispersion at a melting point or higher, followed by finely dividing by a device capable of applying a strong shear.

Examples of the device for finely dispersing by the foregoing mechanical measure include a Manton-Goulin high-pressure homogenizer (manufactured by Goulin Corporation), a continuous ultrasonic homogenizer (manufactured by Nippon Seiki Co., Ltd.), a Nanomizer (manufactured by Nanomizer Inc.), a Microfluidizer (manufactured by Mizuho Industrial Co., Ltd.), a barrel type homogenizer, a slasher (manufactured by Mitsui Mining Co., Ltd.), and a cavitron (manufactured by Eurotec, Ltd.).

As the microcapsule dispersion, an emulsion resulting from dispersing a microcapsule as prepared utilizing the foregoing various microencapsulation methods in a solution containing a water-soluble binder, etc. can be utilized.

Furthermore, the photocurable composition dispersion is obtained by adding and mixing a resin component such as a water-soluble binder, a solvent component such as water, and a surfactant, etc. in various components configuring the photocurable composition and then finely dividing the mixture by a device capable of applying a strong shear.

Incidentally, the particle size of the fine particle which is contained in various dispersions exclusive of the microcapsule dispersion may be suitably not more than 1 μm, and more suitably in the range of from 100 to 300 nm for the purpose of making the adjustment of the toner size and the particle size distribution at desired values easy.

—(a1) First Aggregation Step—

In the first aggregation step, a first aggregated particle is formed in a raw material dispersion containing a microcapsule dispersion having a first component-containing microcapsule dispersed therein and a photocurable composition dispersion having a second component-containing photocurable composition dispersed therein.

In the first aggregation step, after adding an aggregating agent in the raw material dispersion, the mixture is heated as the need arises to aggregate a fine particle in the raw material dispersion, thereby forming the first aggregated particle.

Incidentally, the heating temperature is from room temperature to 40° C., and if desired, the temperature may be further raised to the vicinity of 60° C.

The formation of the aggregated particle is carried out by adding the aggregating agent at room temperature under stirring by a rotatory shear type homogenizer or the like, thereby making a pH of the raw material dispersion acidic (pH=about 2 to 4).

As the aggregating agent which is used in the first aggregation step, a surfactant having reversed polarity to the surfactant which is used as a dispersant to be added in the raw material dispersion, namely not only inorganic metal salts but also divalent or polyvalent metal complexes can be suitably used. In particular, the case of using a metal complex is especially desirable because the use amount of the surfactant can be reduced and charge characteristics are improved.

—(b1) Attachment Step—

In the attachment step, a first resin particle dispersion having a resin particle dispersed therein is added in the raw material dispersion having the first aggregated particle formed therein, thereby attaching the resin particle onto the aggregated particle surface. In this way, it is possible to form a coating layer corresponding to an outer shell portion of the photosensitive or thermosensitive capsule.

The formation of the coating layer can be carried out by additionally adding the first resin particle dispersion in the dispersion in which the aggregated particle (core particle) has been formed in the aggregation step. As a binding resin component which is used in the first resin particle dispersion, any of crystalline resins and amorphous resins may be employed, and a surface lubricant dispersion can also be used together with the first resin particle dispersion. Furthermore, the surface lubricant dispersion may be used in place of the first resin particle dispersion.

Incidentally, a surfactant can be used for emulsion polymerization of a binding resin, dispersion of various fine particle components, aggregation of a finer particle, stabilization of an aggregated particle, and so on. Concretely, it is effective, too to jointly use an anionic surfactant (for example, sulfate bases, sulfonate bases, phosphate bases, and soaps), a cationic surfactant (for example, amine salt types and quaternary ammonium salt types), or nonionic surfactant (for example, polyethylene glycol bases, alkylphenol ethylene oxide adduct bases, and polyhydric alcohol bases). As a dispersing measure, general units, for example, a rotatory shear type homogenizer and medium-containing units such as a ball mill, a sand mill and a Dyno Mill can be used.

—(c1) First Fusion Step—

In the first fusion step, a raw material dispersion containing an aggregated particle onto a surface of which a resin particle is attached is heated to cause fusion, thereby obtaining a first fused particle (photosensitive or thermosensitive capsule).

In the first fusion step, by adjusting the suspension containing an aggregated particle as obtained through the first aggregation step and the attachment step at a pH in the range of from about 6.5 to 8.5, the progress of the aggregation is stopped, and heating is then carried out to fuse the aggregated particle.

The heating is carried out at a temperature of a glass transition temperature or higher or a melting point or higher of the binding resin (and/or the surface lubricant) as used for the formation of the coating layer.

Incidentally, the heating temperature is set up to an extent that the materials which configure the outer shell of the microcapsule are melted and that the outer shell structure does not disappear and is generally determined while taking into consideration the heat resistance of materials which configure the outer shell of the microcapsule and the temperature at which materials which configure the outer shell of the photosensitive or thermosensitive capsule is fusible. In general, the heating temperature may be suitably in the range of from 40 to 90° C., and more suitably in the range of from 50 to 80° C.

When the heating temperature exceeds 90° C., the outer shell of the microcapsule may possibly disappear to cause color development, whereas when it is lower than 40° C., there may be the case where the fusion is not sufficiently achieved so that the photosensitive or thermosensitive particle is decomposed in the past process.

—(d1) Second Aggregation Step—

The foregoing (a1) to (c1) steps are carried out for every kind (color developable color) of the photosensitive or thermosensitive capsule to be dispersed in the toner, thereby preparing two or more kinds of photosensitive or thermosensitive capsule dispersions which can be color developed in a different color from each other.

Subsequently, in the second aggregation step, a second aggregated particle is formed in a mixed solution which is a mixture of the two or more kinds of photosensitive or thermosensitive capsule dispersions and a second resin particle dispersion having a resin particle dispersed therein. Incidentally, dispersions of other components such as a surface lubricant dispersion can be added in the foregoing mixed solution as the need arises.

The second aggregation step is also basically carried out in the same manner as in the first aggregation step, except that a composition of the solution to be used for the aggregation is different. That is, after adding an aggregating agent in the mixed dispersion, the mixture is heated to aggregate the photosensitive or thermosensitive particle and the resin particle in the mixture, thereby forming a second aggregated particle. Incidentally, it may be suitable that during or after the formation of the second aggregated particle, a resin particle dispersion having an amorphous resin particle dispersed therein is additionally added, thereby coating a surface of the second aggregated particle by the amorphous resin particle.

Incidentally, the heating temperature may be suitably a temperature at which the amorphous resin particles can be fused with each other or fused with other materials. Concretely, it may be suitable that the temperature is from several° C. to several tens° C. higher than a glass transition temperature of the amorphous resin particle.

—(e1) Second Fusion Step—

In the second fusion step, the mixed solution containing the second aggregated particle is heated to obtain a second fused particle (toner in a wet state).

In the second fusion step, by adjusting the suspension containing an aggregated particle as obtained through the second aggregation step at a pH in the range of from about 6.5 to 8.5, the progress of the aggregation is stopped, and heating is then carried out to fuse the aggregated particle.

The heating is carried out at a temperature of a glass transition temperature or higher or a melting point or higher of the binding resin as used for the formation of the coating layer.

Incidentally, the heating temperature is determined while taking into consideration the heat resistance of materials which configure the outer shell of the microcapsule, the heat resistance of materials which configure the outer shell of the photosensitive or thermosensitive capsule and the temperature at which the binding resin which is used for the formation of the second aggregated particle is fusible. In general, the heating temperature may be suitably in the range of from 40 to 90° C., and more suitably in the range of from 50 to 70° C.

When the heating temperature exceeds 90° C., the outer shell of the microcapsule may possibly disappear to cause color development, and the second component as dispersed in a photosensitive or thermosensitive capsule which can be color developed in one color may possibly be diffused outside the photosensitive or thermosensitive capsule and further diffused into a photosensitive or thermosensitive capsule which can be color developed in other color so that sufficient color development is not obtained at the time of image formation.

On the other hand, when the heating temperature is lower than 40° C., there may be the case where the fusion is not sufficiently achieved so that the toner particle is decomposed in post steps such as cleaning and drying.

### —Cleaning and Drying Steps and the Like—

After the second fusion step, a desired toner is obtained by going through arbitrary cleaning step, solid-liquid separation step and drying step. However, taking into consideration the charge properties, the cleaning step may be desirably a cleaning step by sufficient displacement with ion exchanged water. Furthermore, though the solid-liquid separation step is not particularly limited, suction filtration, filtration under pressure, and so on may be suitable from the standpoint of productivity. In addition, though the drying step is not particularly limited, freeze drying, flash jet drying, fluidized drying, vibration type fluidized drying, and so on may be suitably employed from the standpoint of productivity. Furthermore, various external additives as described previously can be added in the toner particle after drying as the need arises.

### B. Production Process of Toner Having Concentric Circle Structure:

Next, a production process of a toner having a concentric circle structure utilizing an emulsion aggregation method will be hereunder described.

In this case, first of all, a photosensitive or thermosensitive capsule dispersion is prepared by going through (a2) a first aggregation step for forming a first aggregated particle in a raw material dispersion containing a first microcapsule dispersion having a first component-containing microcapsule dispersed therein and a first photocurable composition dispersion having a second component-containing photocurable composition dispersed therein; (b2) an attachment step for adding a first resin particle dispersion having a resin particle dispersed therein to the raw material dispersion having the aggregated particle formed therein, thereby attaching the resin particle onto the aggregated particle surface; and (c2) a first fusion step for heating the raw material dispersion containing the aggregated particle onto the surface of which the resin particle is attached to cause fusion, thereby obtaining a photosensitive or thermosensitive capsule.

Subsequently, by going through (d2) a photosensitive or thermosensitive layer forming step by adding a raw material dispersion containing a second microcapsule dispersion having a first component-containing microcapsule dispersed therein and a second photocurable composition dispersion having a second component-containing photocurable composition dispersed therein to the foregoing photosensitive or thermosensitive capsule dispersion, thereby forming a photosensitive or thermosensitive layer which can be colored developed in a color different from the photosensitive or thermosensitive capsule on a surface of the photosensitive or thermosensitive capsule; (e2) a coating layer forming step by adding a second resin particle dispersion having a resin particle dispersed therein to the raw material dispersion after the photosensitive or thermosensitive layer forming step to attach the resin particle onto a surface of the photosensitive or thermosensitive layer, thereby forming a coating layer; and (f2) a second fusion step for heating raw material dispersion containing the second aggregated particle in which the coating layer has been formed by attaching the resin particle onto the surface of the photosensitive or thermosensitive layer, thereby obtaining a fused particle. A toner having a concentric circle structure can be obtained.

In the case of preparing a toner having a concentric circle structure containing three or more kinds of color developing parts which can be color developed in a different color from each other, a process of successively carrying out the photosensitive or thermosensitive layer forming step (d2), the coating layer forming step (e2) and the second fusion step (f2) is further repeated one or more times. In this way, it is possible to make the color developable color of each of two or more photosensitive or thermosensitive layers and photosensitive or thermosensitive capsules as formed through the respective photosensitive or thermosensitive forming steps different from each other.

Furthermore, in each of the steps, a dispersion containing other component can be used jointly as the need arises. For example, a surface lubricant dispersion may be utilized in the first aggregation step, the adhesive step, the photosensitive or thermosensitive layer forming step or the coating layer forming step.

Next, each of the steps will be hereunder described in more detail. First of all, the preparation methods of various dispersions to be used in the respective steps are the same as those in the case of preparing the foregoing toner having a photosensitive or thermosensitive capsule dispersion structure.

Furthermore, the (a2) to (c2) steps can be basically carried out in the same manners as the foregoing (a1) to (c1) steps. However, the photosensitive or thermosensitive capsule dispersion which is prepared through the (a2) to (c2) steps is only one kind.

The photosensitive or thermosensitive layer forming step (d2) and the coating layer forming step (e2) to be subsequently carried out can be carried out in the same manners as in the foregoing (a1) and (b1) steps, except that a photosensitive or thermosensitive layer and a coating layer are successively stacked and formed on the photosensitive or thermosensitive capsule particle which becomes a core layer (core particle). In this way, there is obtained a second aggregated particle in which the photosensitive or thermosensitive capsule particle configures a core layer and the photosensitive or thermo-sensitive layer and the coating layer are successively stacked so as to coat this core layer.

Incidentally, the coating layer which is formed in the coating layer forming step (e2) configures a surface layer of coating the toner surface in the case of ultimately forming into a toner, or an interlayer which is provided between the two photosensitive or thermosensitive layers adjacent to each other. Here, in the case where this coating layer configures a surface layer in forming into a toner, it may be especially suitable that a resin particle dispersion using an amorphous resin is used in the coating layer forming step (e2).

The second fusion step (f2) can also be basically carried out in the same manner as in the (e1) step. Incidentally, the heating temperature in the second fusion step is determined while taking into consideration the heat resistance of materials which configure the outer shell of the microcapsule, the heat resistance of materials which configure the outer shell of the photosensitive or thermosensitive capsule or the interlayer (in the case where the (d2) to (f2) steps are carried out repeatedly two or more times) and the temperature at which the binding resin which is used for the formation of the second aggregated particle is fusible. In general, the heating temperature may be suitably in the range of from 40 to 90° C., and more suitably in the range of from 50 to 80° C.

When the heating temperature exceeds 90° C., the outer shell of the microcapsule may possibly disappear to cause color development, and the second component as dispersed in a color developing part (a photosensitive or thermosensitive capsule and/or a photosensitive or thermosensitive layer) which can be color developed in one color may possibly be diffused outside color developing part (the photosensitive or thermosensitive capsule and/or the photosensitive or thermosensitive layer) and further diffused into a color developing part (a photosensitive or thermosensitive capsule and/or a photosensitive or thermosensitive layer) which can be color developed in other color so that sufficient color development is not obtained at the time of image formation.

On the other hand, when the heating temperature is lower than 40° C., there may be the case where the fusion is not sufficiently achieved so that the toner particle is decomposed in post steps such as cleaning and drying.

After the series of steps, a toner can be obtained by carrying out cleaning and drying steps and so on in the same manner.

The volume average particle size of the toner which is used according to an aspect of the invention is not particularly limited and can be properly adjusted depending upon the structure of the toner, the kind and number of color developing parts to be contained in the toner.

However, when the number of kinds of the color developing parts to be contained in the toner, which can be color developed in a different color from each other, is from about two to four (for example, the case where the toner contains three kinds of color developing parts which can be color developed yellow, cyan and magenta, respectively), it may be suitable that the volume average particle size falls within the following range corresponding to each toner structure.

That is, in the case where the structure of the toner is a color developing part-dispersed structure as exemplified in FIG. 6, the volume average particle size of the toner may be suitably in the range of from 5 to 40 μm, and more suitably in the range of from 10 to 20 μm. Furthermore, the volume average particle size of the photosensitive or thermosensitive capsule which is contained in the toner of a photosensitive or thermosensitive capsule-dispersed structure type having such a particle size may be suitably in the range of from 1 to 5 μm, and more suitably in the range of from 1 to 3 μm.

When the volume average particle size is less than 5 μm, since the amount of the color developing component to be contained in the toner is small, the color reproducibility may possibly be deteriorated, or the image density may possibly be lowered. On the other hand, when the volume average particle size exceed 40 μm, irregularities of the image surface become large so that uneven gloss on the image surface may possibly be generated, or the image quality may possibly be lowered.

Incidentally, in the toner of a photosensitive or thermosensitive capsule-dispersed structure type in which plural photosensitive or thermosensitive capsules are dispersed therein, the particle size tends to become large as compared with conventional small-sized toners using a coloring agent (volume average particle size: from about 5 to 10 μm). However, since the resolution of image is determined by not the particle size of the toner but the particle size of the photosensitive or thermosensitive capsule, an image with higher definition can be obtained. In addition, because of good power fluidity, even when the amount of an external additive is small, not only sufficient fluidity can be ensured, but also developability and cleaning properties can be improved.

In the case of a toner of a concentric circle structure type, a stripe structure type or a folding fan structure type as exemplified in FIGS. 7 to 9, respectively, since it is not necessary to consider granulation of the photosensitive or thermosensitive capsule as compared with the toner of a photosensitive or thermosensitive capsule-dispersed structure type, miniaturization in the size is easy. The volume average particle size of this toner may be suitably in the range of from 3 to 40 μm, and more suitably in the range of from 5 to 15 μm. When the volume average particle size is less than 3 μm, the formation itself of the toner may possibly become difficult. On the other hand, when the volume average particle size exceeds 40 μm, irregularities of the image surface become large so that uneven gloss on the image surface may possibly be generated, or the image quality may possibly be lowered.

Furthermore, it may be suitable that the toner according to an aspect of the invention has a volume average particle size distribution index GSDᵥ of not more than 1.30 and a ratio of a volume average particle size distribution index GSDᵥ to a number average particle size distribution index GSDₚ (GSDᵥ/GSDₚ) of 0.95 or more.

It may be more suitable that the toner has a volume average particle size distribution index GSDᵥ of not more than 1.25 and a ratio of a volume average particle size distribution index GSDᵥ to a number average particle size distribution index GSDₚ (GSDᵥ/GSDₚ) of 0.97 or more.

When the volume average particle size distribution index GSDᵥ exceeds 1.30, the resolution of image may possibly be lowered; and when the ratio of a volume average particle size distribution index GSDᵥ to a number average particle size distribution index GSDₚ (GSDᵥ/GSDₚ) is less than 0.95, the charge properties of the toner may possibly be lowered, or image defects due to scattering of the toner, the generation of fog, or the like may possibly be produced.

Incidentally, according to an aspect of the invention, the volume average particle size of the toner and the foregoing volume average particle size distribution index GSDᵥ and number average particle size distribution index GSDₚ values are measured and calculated in the following manners.

First of all, with respect to the particle size distribution of the toner as measured by using an analyzer such as a Coulter Multisizer II (manufactured by Beckman-Coulter), accumulated distribution of the volume and number of individual toner particles is drawn from a side of the small particle size vs. the divided particle size range (channel); a particle size at an accumulation of 16% is defined as a volume average particle size D16ᵥ and a number average particle size D16ₚ; and a particle size at an accumulation of 50% is defined as a volume average particle size D50ᵥ and a number average particle size D50ₚ. Similarly, a particle size at an accumulation of 84% is defined as a volume average particle size D84ᵥ and a number average particle size D84ₚ. On this occasion, the volume average particle size distribution index (GSDᵥ) is defined as (D84ᵥ/D16ᵥ)^{1/2}; and the number average particle size distribution index (GSDₚ) is defined as (D84ᵥ/D16ₚ)^{1/2}. By using these relational expressions, the volume average particle size distribution (GSDᵥ) and the number average particle size distribution index (GSDₚ) can be calculated.

Furthermore, the volume average particle size of the foregoing microcapsule and photosensitive or thermosensitive capsule can be measured by using, for example, a laser diffraction type particle size distribution analyzer (LA-700, manufactured by Horiba, Ltd.).

Furthermore, the toner according to an aspect of the invention may suitably have a shape factor SF1 as represented by the following expression (2) in the range of from 110 to 130.

SF1=(ML²/A)×(π/4)×100 (2)

In the foregoing expression (2), ML represents a maximum length (μm) of the toner; and A represents a projected area (μm²) of the toner.

When the shaper factor SF1 is less than 110, since the toner likely remains on a surface of the image carrier in the transfer step during the image formation, the removal of this residual toner is necessary. On that occasion, the cleaning properties in cleaning by a blade, etc. is liable to be deteriorated. As a result, image defects may possibly be generated.

On the other hand, when the shape factor SF1 exceeds 130, in the case where the toner is used as a developing agent, the toner may possibly be broken due to a collision with the carrier within the developing unit. On this occasion, as a result, the amount of fine powders increases so that the surface of image carrier or the like is stained by the surface lubricant which has been exposed on the toner surface, thereby possibly deteriorating the charge characteristic. Also, there may be possibly generated a problem such as the generation of fog as caused due to the fine powder.

The shape factor SF1 is measured by using a Luzex image processor (FT, manufactured by Nireco Corporation) in the following manner. First of all, an optical microscopic image of the toner as sprayed on a slide glass is captured on a Luzex image processor through a video camera; the maximum length (ML) and the projected area (A) are measured with respect to 50 or more toners; and with respect to the individual toner, a square of the maximum length and the projected area are calculated, from which the shape factor SF1 according to the foregoing expression (2) is then determined.

Incidentally, for the purposes of applying fluidity and improving cleaning properties, like usual toners, after drying, an inorganic particle (for example, silica, alumina, titania, and calcium carbonate) or a resin particle (for example, vinyl based resins, polyesters, and silicones) can be added as a fluidity auxiliary or a cleaning auxiliary onto the surface of the toner according to an aspect of the invention while applying a shear in a dry state.

Examples of the inorganic oxide fine particle which is added in the toner include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCo₃, MgCO₃, BaSO₄, and MgSO₄. Of these, a silica fine particle and a titania fine particle are especially desirable. It may be desired that the surface of the inorganic oxide fine particle is made hydrophobic in advance. This hydrophobic treatment is more effective for not only improving the powder fluidity of toner but also the environmental dependency of electrification and resistance to carrier staining.

### <Developer>

Though the toner which is used according to an aspect of the invention may be used as a one-component developing agent as it stands, it may be suitably used as a toner in a two-component developing agent made of a carrier and a toner according to an aspect of the invention.

Here, from the standpoint of the matter that a color image can be formed with one kind of a developing agent, the developing agent may be suitably (1) a developing agent of a type having one kind of a toner having two or more kinds of color developing parts containing the foregoing photocurable composition and a microcapsule as dispersed in the photocurable composition, with the two or more kinds of color developing parts as contained in the toner being able to be color developed in a different color from each other; or (2) a developing agent of a type having two or more kinds of toners having one color developing part containing the foregoing photocurable composition and a microcapsule as dispersed in the photocurable composition in a mixed state, with the color developing parts of the two or more kinds of toners being able to be color developed in a different color from each other.

For example, in the developing agent of the former type, it may be suitable that three kinds of color developing parts are contained in the toner and that the three kinds of color developing parts are made of a yellow color developing part capable of being color developed in a yellow color, a magenta color developing part capable of being color developed in a magenta color and a cyan color developing part capable of being color developed in a cyan color, respectively; and in the developing agent of the latter type, it may be suitable that a yellow color developing toner whose color developing part is able to be color developed in a yellow color, a magenta color developing toner whose color developing part is able to be color developed in a magenta color and a cyan color developing toner whose color developing part is able to be color developed in a cyan color are contained in a mixed state.

The carrier which can be used in a two-component developing agent may be suitably a carrier in which a resin is coated on a surface of a core material. The core material of the carrier is not particularly limited by satisfying the foregoing conditions, and examples thereof include magnetic metals such as iron, steel, nickel, and cobalt; alloys thereof with manganese, chromium, a rare earth metal, or the like; and magnetic oxides such as ferrite and magnetite of these, from the viewpoints of surface properties of the core material and resistivity of the core material, ferrite is suitable; and alloys with manganese, lithium, strontium, magnesium, or the like are especially suitable.

Furthermore, the resin for coating the surface of the core material is not particularly limited so far as it can be used as a matrix resin and can be properly selected depending upon the purpose.

In the foregoing two-component developer, a mixing ratio (weight ratio) of the toner according to an aspect of the invention and the foregoing carrier may be suitably in the range of from about 1/100 to 30/100, and more suitably from about 3/100 to 20/100 in terms of a ratio of the toner to the carrier.

### EXAMPLES

The invention will be more specifically described below with reference to the following Examples, but it should not be construed that that invention is limited only to the following Examples. Incidentally, the terms “part” and “%” in the following Examples express “part by mass” and “% by mass”, respectively.

### <Preparation of Toner>

First of all, toners which are used in the following Examples will be described. Incidentally, in the preparation of a toner, the preparation of a photocurable composition dispersion and the preparation of a series of toners using the same are all carried out in a dark place.

### A. Light Non-Color Development Type Toner:

### (Preparation of Microcapsule Dispersion)

### —Microcapsule Dispersion (1)—

8.9 parts of an electron donating colorless dye (1) which is able to be color developed yellow is dissolved in 16.9 parts of ethyl acetate, to which 20 parts of a capsule wall material (a trade name: TAKENATE D-110N, manufactured by Takeda Pharmaceutical Company Limited) and 2 parts of a capsule wall material (a trade name: MILLIONATE MR200, manufactured by Nippon Polyurethane Industry Co., Ltd.) are then added.

The resulting solution is added in a mixed solution of 42 parts of 8% phthalated gelatin, 14 parts of water and 1.4 parts of a 10% sodium dodecylbenzenesulfonate solution, and the mixture is then emulsified and dispersed at a temperature of 20° C. to obtain an emulsion. Next, 72 parts of a 2.9% tetraethylenepentamine aqueous solution is added to the resulting emulsion, and the mixture is heated to 60° C while stirring. After a lapse of 2 hours, there is obtained a microcapsule dispersion (1) containing the electron donating colorless dye (1) in a core part thereof and having an average particle size of 0.5 μm.

Incidentally, a material which configures an outer shell of the microcapsule as contained in this microcapsule dispersion (1) (this material is a material resulting from reaction of TAKANATE D-110 and MILLIONATE MR200 under substantially the same condition as described previously) has a glass transition temperature of 100° C.

### —Microcapsule Dispersion (2)—

A microcapsule dispersion (2) is obtained in the same manner as in the case of preparing the microcapsule dispersion (1), except for changing the electron donating colorless dye (1) to an electron donating colorless dye (2). A microcapsule in this dispersion has an average particle size of 0.5 μm.

### —Microcapsule Dispersion (3)—

A microcapsule dispersion (3) is obtained in the same manner as in the case of preparing the microcapsule dispersion (1), except for changing the electron donating colorless dye (1) to an electron donating colorless dye (3). A microcapsule in this dispersion has an average particle size of 0.5 μm.

Incidentally, chemical structural formulae of the electron donating colorless dyes (1) to (3) each of which is used for preparing a microcapsule dispersion are shown below.

Electron donating colorless dye (1)

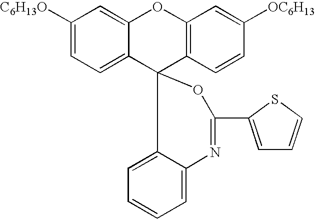

Electron donating colorless dye (2)

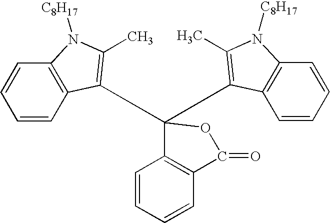

Electron donating colorless dye (3)

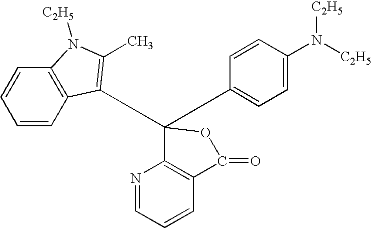

### (Preparation of Photocurable Composition Dispersion)

### —Photocurable Composition Dispersion (1)—

100.0 parts of a mixture of polymerizable group-containing electron accepting compounds (1) and (2) (mixing ratio: 50/50) and 0.1 parts of a heat polymerization inhibitor (ALI) are dissolved in 125.0 parts of isopropyl acetate (solubility in water: about 4.3%) at 42° C. to prepare a mixed solution I.

18.0 parts of a hexaarylbiimidazole (1) [2,2′-bis(2-chlorophenyl)-4,4′,5,5′-tetraphenyl-1,2′-biimidazole], 0.5 parts of a nonionic organic dye and 6.0 parts of an organic boron compound are added in this mixed solution I and dissolved at 42° C. to prepare a mixed solution II.

The mixed solution II is added in a mixed solution of 300.1 parts of an 8% gelatin aqueous solution and 17.4 parts of a 10% aqueous solution of a surfactant (1) ; the mixture is emulsified at a number of revolution of 10,000 rpm for 5 minutes by using a homogenizer (manufactured by Nippon Seiki Co., Ltd.); and the emulsion is then subjected to a desolvation treatment at 40° C. for 3 hours to obtain a photocurable composition dispersion (1) having a solids content of 30%.

### —Photocurable Composition Dispersion (2)—

5 parts of the following polymerizable group-containing electron accepting compound (3) is added in a mixed solution of 0.6 parts of the following organic borate compound (I) (borate compound II), 0.1 parts of the following spectral sensitizing dye based borate compound (I) (borate compound II), 0.1 parts of the following auxiliary (1) for the purpose of achieving high sensitivity and 3 parts of isopropyl acetate (solubility in water: about 4.3%).

The resulting solution is added in a mixed solution of 13 parts of a 13% gelatin aqueous solution, 0.8 parts of a 2% aqueous solution of the following surfactant (2) and 0.8 parts of a 2% aqueous solution of the following surfactant (3), and the mixture is emulsified at a number of revolution of 10,000 rpm for 5 minutes by using a homogenizer (manufactured by Nippon Seiki Co., Ltd.) to obtain a photocurable composition dispersion (2).

### —Photocurable Composition Dispersion (3)—

A photocurable composition dispersion (3) is obtained in the same manner as in the case of preparing the photocurable composition dispersion (2), except for using 0.1 parts of the foregoing spectral sensitizing dye based borate compound (II) (borate compound II) in place of the spectral sensitizing based borate compound (I).

Incidentally, structural formulae of the polymerizable group-containing electron accepting compound (1), the polymerizable group-containing electron accepting compound (2), the heat polymerization inhibitor (ALI), the hexaarylbiimidazole (1), the surfactant (1), the nonionic organic dye and the organic boron compound which are used in preparing the photocurable composition dispersion (1) are shown below.

Furthermore, structural formulae of the organic borate compound (I), the spectral sensitizing dye based borate compound (I), the polymerizable group-containing electron accepting compound (3), the auxiliary (1), the surfactant (2) and the surfactant (3) which are used in preparing the photocurable composition dispersion (2) are shown below,

Moreover, a structural formula of the spectral sensitizing dye based borate compound (II) which is used in preparing the photocurable composition dispersion (3) is shown below.

Polymerizable electron accepting compound

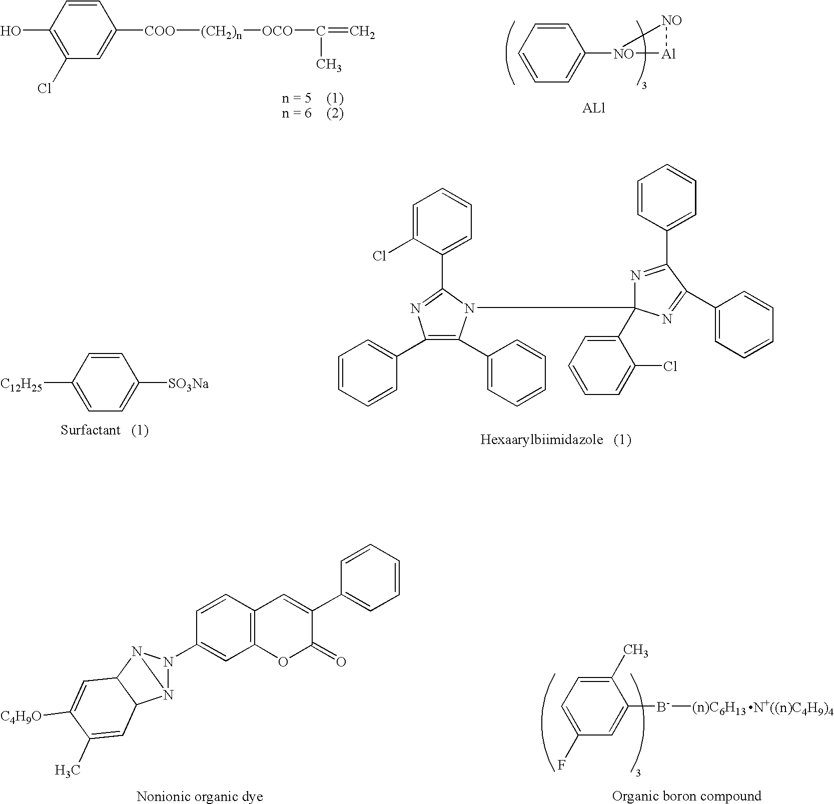

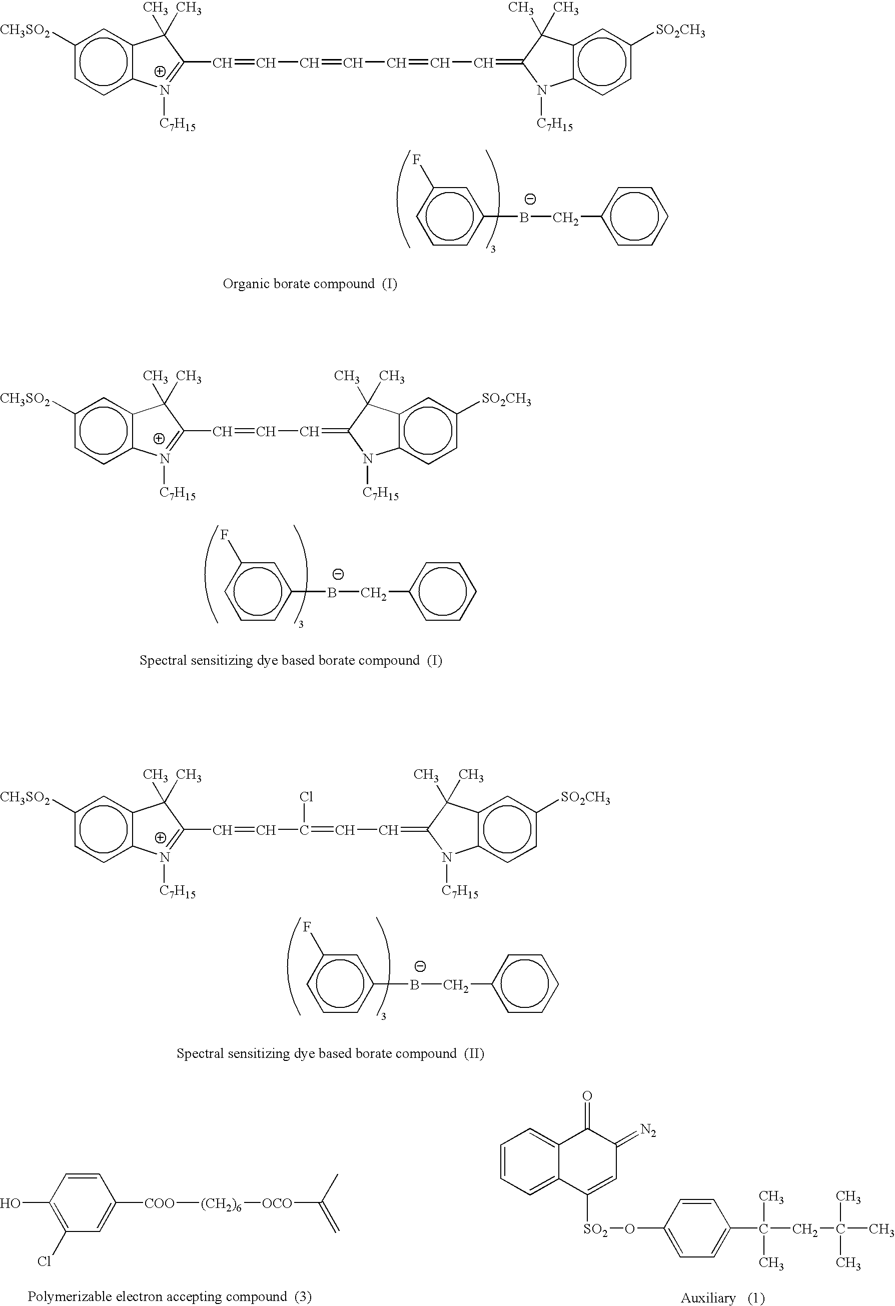

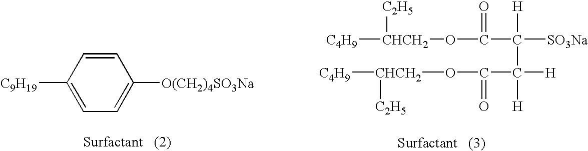

### (Preparation of Resin Particle Dispersion)

Styrene: 460 parts
n-Butyl acrylate: 140 parts
Acrylic acid: 12 parts
Dodecanethiol: 9 parts

The foregoing components are mixed and dissolved to prepare a solution. Subsequently, this solution is added in a solution of 12 parts of an anionic surfactant (DOWFAX, manufactured by Rhodia, Inc.) dissolved in 250 parts of ion exchanged water, and the mixture is dispersed and emulsified in a flask to prepare an emulsion (monomer emulsion A).

Furthermore, 1 part of an anionic surfactant (DOWFAX, manufactured by Rhodia, Inc.) is dissolved in 555 parts of ion exchanged water and charged in a polymerization flask. The polymerization flask is stopped tightly and provided with a reflux tube. The polymerization flask is heated to 75° C. in a water bath while pouring nitrogen under gentle stirring and then held.

Next, a solution of 9 parts of ammonium persulfate dissolved in 43 parts of ion exchanged water is added dropwise in the polymerization flask over 20 minutes via a metering pump, and the monomer emulsion A is also added dropwise over 200 minutes via a metering pump.

Thereafter, the polymerization flask is held at 75° C. for 3 hours while continuing gentle stirring, thereby completing the polymerization.

There is thus obtained a resin particle dispersion having a median size of particle of 210 nm, a glass transition point of 51.5° C., a weight average molecular weight of 31,000, and a solids content of 42%.

### (Preparation of Toner 1 (Color Developing Part-Dispersed Structure Type))

### —Preparation of Photosensitive or Thermosensitive Capsule Dispersion (1)—

Microcapsule dispersion (1): 150 parts
Photocurable composition dispersion (1): 300 parts
Poly(aluminum chloride): 0.20 parts
Ion exchanged water: 300 parts

Nitric acid is added in a raw material solution resulting from mixing the foregoing components to adjust at a pH of 3.5; after thoroughly mixing and dispersing by a homogenizer (ULTRA TURAX T50, manufactured by IKA Inc.), the dispersion is transferred into a flask and heated to 40° C. on an oil bath for heating with stirring by a three one motor; and after holding at 40° C. for 60 minutes, 300 parts of a resin particle dispersion is further added and gently stirred at 60° C. for 2 hours. There is thus obtained a photosensitive or thermosensitive capsule dispersion (1).

Incidentally, a photosensitive or thermosensitive capsule which is dispersed in this dispersion has a volume average particle size of 3.53 μm. Furthermore, spontaneous color development of the dispersion at the time of preparing this dispersion is not confirmed.

### —Preparation of Photosensitive or Thermosensitive Capsule Dispersion (2)—

Microcapsule dispersion (2): 150 parts
Photocurable composition dispersion (2): 300 parts
Poly(aluminum chloride): 0.20 parts
Ion exchanged water: 300 parts

A photosensitive or thermosensitive capsule dispersion (2) is obtained in the same manner as in the case of preparing the photosensitive or thermosensitive capsule dispersion (1), except for using the foregoing components as a raw material solution.

Incidentally, a photosensitive or thermosensitive capsule which is dispersed in this dispersion has a volume average particle size of 3.52 μm. Furthermore, spontaneous color development of the dispersion at the time of preparing this dispersion is not confirmed.

### —Preparation of Photosensitive or Thermosensitive Capsule Dispersion (3)—

Microcapsule dispersion (3): 150 parts
Photocurable composition dispersion (3): 300 parts
Poly(aluminum chloride): 0.20 parts
Ion exchanged water: 300 parts

A photosensitive or thermosensitive capsule dispersion (3) is obtained in the same manner as in the case of preparing the photosensitive or thermosensitive capsule dispersion (1), except for using the foregoing components as a raw material solution.

Incidentally, a photosensitive or thermosensitive capsule which is dispersed in this dispersion has a volume average particle size of 3.47 μm. Furthermore, spontaneous color development of the dispersion at the time of preparing this dispersion is not confirmed.

### —Preparation of Toner—

Photosensitive or thermosensitive capsule dispersion (1): 750 parts
Photosensitive or thermosensitive capsule dispersion (2): 750 parts
Photosensitive or thermosensitive capsule dispersion (3): 750 parts

A solution resulting from mixing the foregoing components is transferred into a flask and heated to 42° C. on an oil bath for heating while stirring the inside of the flask; and after holding at 42° C. for 60 minutes, 100 parts of a resin particle dispersion is further added and gently stirred.

Thereafter, the inside of the flask is adjusted at a pH of 5.0 with a sodium hydroxide aqueous solution of 0.5 moles/liter, and the mixture is heated to 55° C. while continuing stirring. In a usual case, the pH in the flask is lowered to not more than 5.0 during a period of temperature rise to 55° C. However, in the present case, a sodium hydroxide aqueous solution is further added dropwise such that the pH does not drop to not more than 4.5. This state is held at 55° C. for 3 hours.

After completion of the reaction, the reaction mixture is cooled, filtered and thoroughly washed with ion exchanged water, followed by subjecting to solid-liquid separation by Nutsche type suction filtration. The solid is again dispersed in 3 liters of ion exchanged water at 40° C. in a 5-liter beaker and stirred at 300 rpm for 15 minutes, followed by washing. This washing operation is repeated 5 times and subjected to solid-liquid separation by Nutsche type suction filtration. Next, the solid is freeze dried in vacuo for 12 hours to obtain a toner particle having a photosensitive or thermosensitive capsule dispersed in the styrene based resin. A particle size of this toner particle is measured by a Coulter counter and found to be 15.2 μm in terms of a volume average particle size D50ᵥ. Subsequently, 1.0 part of hydrophobic silica (TS720, manufactured by Cabot Corporation) is added to 50 parts of this toner particle and mixed by a sample mill to obtain an external additive toner 1.

### (Preparation of Toner 2 (Concentric Circle Structure Type))

### —Preparation of Toner—

Microcapsule dispersion (1): 150 parts
Photocurable composition dispersion (1): 300 parts
Poly(aluminum chloride): 0.20 parts
Ion exchanged water: 300 parts

Nitric acid is added in a solution resulting from mixing the foregoing components to adjust at a pH of 3.5; after thoroughly mixing and dispersing by a homogenizer (ULTRA TURAX T50, manufactured by IKA Inc.), the dispersion is transferred into a flask and heated to 40° C. on an oil bath for heating with stirring by a three one motor; and after holding at 40° C. for 60 minutes, 300 parts of a resin particle dispersion is further added and gently stirred.

Thereafter, the inside of the flask is adjusted at a pH of 7.5 with a sodium hydroxide aqueous solution of 0.5 moles/liter, the mixture is heated to 60° C. while continuing stirring, and the stirring is gently continued at 60° C. for 2 hours. The reaction mixture is once taken out from the flask and allowed to stand for cooling to obtain a photosensitive or thermosensitive capsule dispersion.

Incidentally, a photosensitive or thermosensitive capsule which is dispersed in this dispersion has a volume average particle size of 4.50 μm. Furthermore, spontaneous color development of the dispersion at the time of preparing this dispersion is not confirmed.

Subsequently, a mixed solution of the following components is added in this photosensitive or thermosensitive capsule dispersion, and after adjusting at a pH of 3.5 with nitric acid, the mixture is thoroughly mixed and dispersed by a homogenizer (ULTRA TURAX T50, manufactured by IKA).
Microcapsule dispersion (2): 150 parts
Photocurable composition dispersion (2): 300 parts
Poly(aluminum chloride): 0.20 parts
Ion exchanged water: 300 parts

Next, the solution after mixing and dispersing is again transferred into the flask and heated to 40° C. on an oil bath for heating with stirring by a three one motor; and after holding at 40° C. for 60 minutes, 200 parts of a resin particle dispersion is further added and gently stirred.

Thereafter, the inside of the flask is adjusted at a pH of 7.5 with a sodium hydroxide aqueous solution of 0.5 moles/liter, the mixture is heated to 60° C. while continuing stirring, and the stirring is gently continued at 60° C. for 2 hours. The reaction mixture is once taken out from the flask and allowed to stand for cooling to obtain a photosensitive or thermosensitive capsule dispersion.

Incidentally, a photosensitive or thermosensitive capsule which is dispersed in this dispersion has a volume average particle size of 6.0 μm. Furthermore, spontaneous color development of the dispersion at the time of preparing this dispersion is not confirmed.

Subsequently, a mixed solution of the following components is added in this photosensitive or thermosensitive capsule dispersion, and after adjusting at a pH of 3.5 with nitric acid, the mixture is thoroughly mixed and dispersed by a homogenizer (ULTRA TURAX T50, manufactured by IKA).
Microcapsule dispersion (3): 150 parts
Photocurable composition dispersion (3): 300 parts
Poly(aluminum chloride): 0.20 parts
Ion exchanged water: 300 parts

Next, the solution after mixing and dispersing is again transferred into the flask and heated to 40° C. on an oil bath for heating with stirring by a three one motor; and after holding at 40° C. for 60 minutes, 100 parts of a resin particle dispersion is further added and gently stirred at 60° C. for 2 hours.

Thereafter, the inside of the flask is adjusted at a pH of 5.0 with a sodium hydroxide aqueous solution of 0.5 moles/liter, and the mixture is heated to 55° C. while continuing stirring. In a usual case, the pH in the flask is lowered to not more than 5.0 during a period of temperature rise to 55° C. However, in the present case, a sodium hydroxide aqueous solution is further added dropwise such that the pH does not drop to not more than 4.5. This state is held at 55° C. for 3 hours. Incidentally, spontaneous color development of the dispersion at the time of preparing this dispersion is not confirmed.

After completion of the reaction, the reaction mixture is cooled, filtered and thoroughly washed with ion exchanged water, followed by subjecting to solid-liquid separation by Nutsche type suction filtration. The solid is again dispersed in 3 liters of ion exchanged water at 40° C. in a 5-liter beaker and stirred at 300 rpm for 15 minutes, followed by washing. This washing operation is repeated 5 times and subjected to solid-liquid separation by Nutsche type suction filtration. Next, the solid is freeze dried in vacuo for 12 hours to obtain a toner particle.

A particle size of this toner particle is measured by a Coulter counter and found to be 7.5 μm in terms of a volume average particle size D50ᵥ. 1.0 part of hydrophobic silica (TS720, manufactured by Cabot Corporation) is added to 50 parts of this toner particle and mixed by a sample mill to obtain an external additive toner 2.

### B. Light Color Development Type Toner:

### (Preparation of Microcapsule Dispersion)

### —Microcapsule Dispersion (1)—

12.1 parts of the foregoing electron donating colorless dye (1) is dissolved in 10.2 parts of ethyl acetate, to which 12.1 parts of dicyclohexyl phthalate, 26 parts of TAKENATE D-110N (manufactured by Takeda Pharmaceutical Company Limited) and 2.9 parts of MILLIONATE MR200 (manufactured by Nippon Polyurethane Industry Co., Ltd.) are then added to prepare a solution.

Subsequently, this solution is added in a mixed solution of 5.5 parts of polyvinyl alcohol and 73 parts of water, and the mixture is emulsified and dispersed at 20° C. to obtain an emulsion having an average particle size of 0.5 μm. 80 parts of water is added to the resulting emulsion, and the mixture is heated to 60° C. while stirring. After a lapse of 2 hours, there is obtained a microcapsule dispersion (1) in which a microcapsule having the electron donating colorless dye (1) as a core material is dispersed therein.

Incidentally, a material which configures an outer shell of the microcapsule as contained in this microcapsule dispersion (1) (this material is a material resulting from reaction of dicyclohexyl phthalate, TAKANATE D-110N and MILLIONATE MR200 under substantially the same condition as described previously) has a glass transition temperature of about 130° C.

### —Microcapsule Dispersion (2)—

A microcapsule dispersion (2) is obtained in the same manner as in the case of preparing the microcapsule dispersion (1), except for changing the electron donating colorless dye (1) to the foregoing electron donating colorless dye (2).

### —Microcapsule Dispersion (3)—

A microcapsule dispersion (3) is obtained in the same manner as in the case of preparing the microcapsule dispersion (1), except for changing the electron donating colorless dye (1) to the foregoing electron donating colorless dye (3).

### (Preparation of Photocurable Composition Dispersion)

### —Photocurable Composition Dispersion (1)—

9 parts of an electron accepting compound (1) and 7.5 parts of a trimethylolpropane triacrylate monomer (trifunctional monomer, molecular weight: about 300) are added in a solution of 1.62 parts of a photopolymerization initiator (1-a) and 0.54 parts of a photopolymerization initiator (1-b) dissolved in 4 parts of ethyl acetate.

The thus obtained solution is added in a mixed solution resulting from mixing 19 parts of a 15% PVA (polyvinyl alcohol) aqueous solution, 5 parts of water, 0.8 parts of a 2% aqueous solution of a surfactant (1) and 0.8 parts of a 2% aqueous solution of a surfactant (2), and the mixture is emulsified at a number of revolution of 8,000 rpm for 7 minutes by using a homogenizer (manufactured by Nippon Seiki Co., Ltd.) to obtain a photocurable composition dispersion (1) as an emulsion.

### —Photocurable Composition Dispersion (2)—

A photocurable composition dispersion (2) is obtained in the same manner as in the case of preparing the photocurable composition dispersion (1), except for changing the photopolymerization initiators (1-a) and (1-b) to 0.08 parts of a photopolymerization initiator (2-a), 0.18 parts of a photopolymerization initiator (2-b) and 0.18 parts of a photopolymerization initiator (2-c).

### —Photocurable Composition Dispersion (3)—

A photocurable composition dispersion (3) is obtained in the same manner as in the case of preparing the photocurable composition dispersion (1), except for changing the photopolymerization initiator (2-b) as used in the foregoing photocurable composition dispersion (2) to a photopolymerization initiator (3-b).

Incidentally, chemical structural formulae of the photopolymerization initiators (1-a), (1-b), (2-a), (2-b), (2-c) and (3-b) used to prepare the photocurable composition dispersion, the electron accepting compound (1) and the surfactants (1) to (2) are shown below.

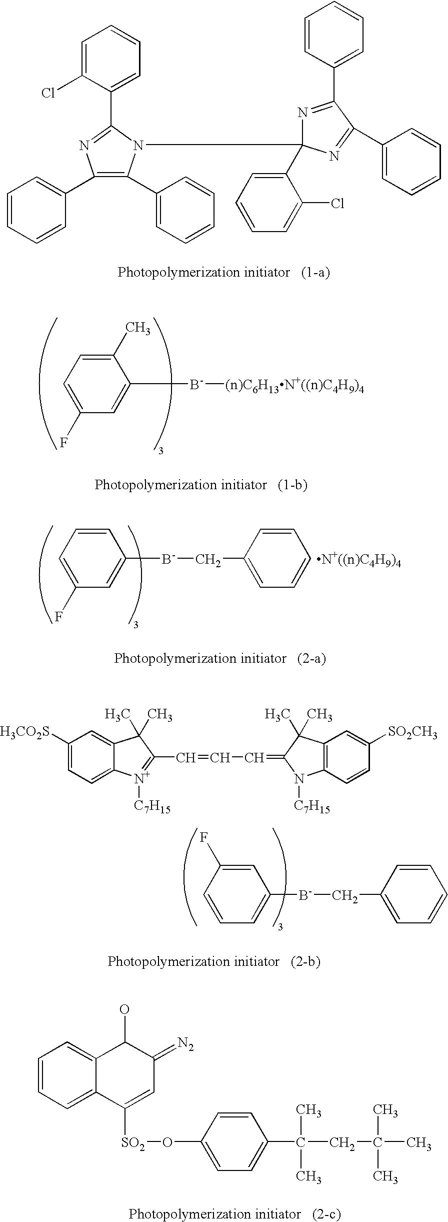

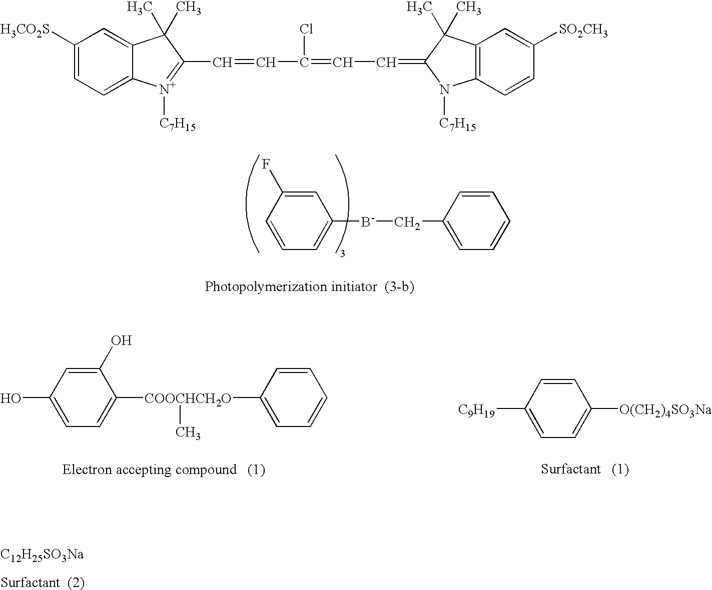

### —Preparation of Resin Particle Dispersion (1)—

Styrene: 360 parts
n-Butyl acrylate: 40 parts
Acrylic acid: 4 parts
Dodecanethiol: 24 parts
Carbon tetrabromide: 4 parts

A solution resulting from mixing and dissolving the foregoing components is dispersed and emulsified in a solution of 6 parts of a nonionic surfactant (NONIPOL 400, manufactured by Sanyo Chemical Industries, Ltd.) and 10 parts of an anionic surfactant (NEOGEN SC, manufactured by Dai-ichi Kogyo Seiyaku Co., Ltd.) dissolved in 560 parts of ion exchanged water in a flask, to which 50 parts of ion exchanged water having 4 parts of ammonium persulfate dissolved therein is then added while gently mixing over 10 minutes.

Subsequently, after purging the inside of the flask with nitrogen, the mixture is heated on an oil bath while stirring the inside of the flask until the contents reach 70° C., and emulsion polymerization is continued for 5 hours at it stands. There is thus obtained a resin particle dispersion (1) having dispersed therein a resin particle having a volume average particle size of 200 nm, a glass transition temperature of 50° C., a weight average molecular weight (Mw) of 16,200 and a specific gravity of 1.2 (resin particle concentration: 30%).

### —Preparation of Photosensitive or Thermosensitive Capsule Dispersion (1)—

Microcapsule dispersion (1): 24 parts
Photocurable composition dispersion (1): 232 parts

The foregoing are thoroughly mixed and dispersed in a round stainless steel-made flask by ULTRA TURAX T50 as manufactured by IKA.

Then, the dispersion is adjusted at a pH of 3 with nitric acid, to which 0.20 parts of poly(aluminum chloride) is then added, and a dispersing operation by using ULTRA TURAX is continued at a number of revolution of 6,000 rpm for 10 minutes. The dispersion is heated to 40° C. on an oil bath for heating while gently stirring the flask.

Here, 60 parts of the resin particle dispersion (1) is further added step by step.

There is thus obtained a photosensitive or thermo-sensitive capsule dispersion (1). Incidentally, a photo-sensitive or thermosensitive capsule which is dispersed in this dispersion has a volume average particle size of about 2 μm. Furthermore, spontaneous color development of the obtained dispersion is not confirmed.

### —Preparation of Photosensitive or Thermosensitive Capsule Dispersion (2)—

A photosensitive or thermosensitive capsule dispersion (2) is obtained by producing in the same manner as in the preparation of the photosensitive or thermosensitive capsule dispersion (1), except for changing the microcapsule dispersion (1) and the photocurable composition dispersion (1) to the microcapsule dispersion (2) and the photocurable composition dispersion (2), respectively. Incidentally, a photosensitive or thermosensitive capsule which is dispersed in this dispersion has a volume average particle size of about 2 μm. Furthermore, spontaneous color development of the obtained dispersion is not confirmed.

### —Preparation of Photosensitive or Thermosensitive Capsule Dispersion (3)—

A photosensitive or thermosensitive capsule dispersion (3) is obtained in the same manner as in the preparation of the photosensitive or thermosensitive capsule dispersion (1), except for changing the microcapsule dispersion (1) and the photocurable composition dispersion (1) to the microcapsule dispersion (3) and the photocurable composition dispersion (3), respectively. Incidentally, a photosensitive or thermo-sensitive capsule which is dispersed in this dispersion has a volume average particle size of about 2 μm. Furthermore, spontaneous color development of the dispersion at the time of preparing this dispersion is not confirmed.

### (Preparation of Toner 3 (Color Developing Part-Dispersed Structure Type))

### —Preparation of Toner—

Photosensitive or thermosensitive capsule dispersion (1): 80 parts
Photosensitive or thermosensitive capsule dispersion (2): 80 parts
Photosensitive or thermosensitive capsule dispersion (3): 80 parts
Resin particle dispersion (1): 80 parts

The foregoing components are thoroughly mixed and dispersed in a round stainless steel-made flask by ULTRA TURAX T50 as manufactured by IKA.

Next, 0.1 parts of poly(aluminum chloride) is added, and a dispersing operation by using ULTRA TURAX is continued at a number of revolution of 6,000 rpm for 10 minutes. The dispersion is heated to 48° C. on an oil bath for heating while stirring the flask. After holding at 48° C. for 60 minutes, 20 parts of the resin particle dispersion (1) is further added step by step.

Thereafter, the inside of the flask is adjusted at a pH of 8.5 with a sodium hydroxide aqueous solution of 0.5 moles/liter. The stainless steel-made flask is then stopped tightly, and the mixture is heated to 55° C. while continuing stirring by using a magnetic seal and held for 10 hours.

After completion of the reaction, the reaction mixture is cooled, filtered and thoroughly washed with ion exchanged water, followed by subjecting to solid-liquid separation by Nutsche type suction filtration. The solid is again dispersed in one liter of ion exchange water at 40° C., and the dispersion is stirred at 300 rpm for 15 minutes, followed by washing.

This operation is repeated 5 times, and when the filtrate has a pH of 7.5 and an electric conductivity of 7.0 μS/cmt, solid-liquid separation is carried out by using No. 5A filter paper by Nutsche type suction filtration. Next, the solid is dried in vacuo for 12 hours to obtain a toner particle having a structure in which the three kinds of photosensitive or thermosensitive capsules are dispersed in a matrix.

A particle size at this time is measured by a Coulter counter and found to be about 15 μm in terms of a volume average particle size D50ᵥ. Furthermore, spontaneous color development of the resulting toner is not confirmed.

Next, 100 parts of this toner (1), 0.3 parts of hydrophobic titania having being subjected to a surface treatment with n-decyltrimethoxysilane and having an average particle size of 15 nm and 0.4 parts of hydrophobic silica having an average particle size of 30 nm (NY50, manufactured by Nippon Aerosil Co., Ltd.) are blended at a peripheral velocity of 32 m/s for 10 minutes by using a Henschel mixer. Thereafter, coarse particles are moved by using a sieve having an opening of 45 μm to obtain an external additive toner 3 having an external additive added thereto.

### <Preparation of Developing Agent>

Next, a ferrite carrier having an average particle size of 50 μm in which a surface of a carrier core material is coated with polymethyl methacrylate (manufactured by Soken Chemical & Engineering Co., Ltd.) (use amount of polymethyl methacrylate based on the total weight of carrier: 1% by mass) is used, each of the foregoing external additive toners 1 to 3 is weighed such that the toner concentration is 5% by mass, and the both are stirred and mixed in a ball mill for 5 minutes to prepare developing agents 1 to 3.

### Example 1

### (Image Formation)

An image forming device as illustrated in FIG. 1 is prepared, and the developing agent 1 is used as a developing agent.

A dielectric drum in which a transparent dielectric layer (acrylic resin layer) having a thickness of 20 μm is formed on the periphery of an aluminum tube stock drum having a diameter of 30 mm (reflectance: 95%) is used as the image carrier 10.

An ion flow control head having control slits (slit-provided control electrodes) as configured at a resolution of 600 dpi on an entire surface of a corona charger (ion generation region) is used as the electrostatic latent image forming device 12.

The developing device 14 is a developing device which is provided with a metal sleeve for two-component magnetic brush development and which is capable of carrying out reversal development. Incidentally, when the foregoing developing agent 1 is charged in this developing unit, a toner charge amount is from about −5 to −30 μC/g.

The color information applying device 16 is an LED image bar with a resolution of 600 dpi which is capable of irradiating lights having a peak wavelength of 405 nm (exposure amount: 0.2 mJ/m²), 532 nm (exposure amount: 0.2 mJ/m²) and 657 nm (exposure amount: 0.4 mJ/m²) respectively.

The transfer device 18 includes, as a transfer roll, a semiconductor roll resulting from coating a conductive elastic material on the outer periphery of a conductive core material. The conductive elastic material is a material having two kinds of carbon blacks made of Ketjenblack and Thermal Black dispersed in a non-compatible blend made of a mixture of NBR and EPDM and having a volume resistivity of 10^{8.5} Ωcm and an Asker C hardness of 35 degrees.

A fixing unit which is used in DPC1616 as manufactured by Fuji Xerox Co., Ltd. is used as the fixing device 24 and arranged at a position of 30 cm far from a color information applying point. Furthermore, a high-luminance Schaukasten including three wavelengths of the foregoing color information applying device is used as the light irradiating device 26, and an irradiation width is set up at 5 mm.

By the image forming device having the foregoing configuration, a printing condition is set up as follows. p0 Image carrier linear velocity: 10 mm/sec
Electrostatic latent image forming condition: The control slits are controlled corresponding to a logical add of image information of four Y, M, C and black colors, a voltage of 8 kV is applied to an ion generation source (corona charger), and a plus ion is applied to form an electrostatic latent image.
Development bias: A rectangular wave of an alternating current Vppl. of 2 kV (3 kHz) is superimposed on a direct current of −330 V.
Developer contact condition: A peripheral velocity ratio (developing roll/image carrier) is set up at 2.0; a development gap is set up at 0.5 mm; a weight of the developing agent on the developing roll is set up at 400 g/m²; and a toner development amount on the image carrier is set up at 5 g/m² with respect to a solid image.
Transfer bias: A direct current of +800 V is applied.
Fixing temperature: A surface temperature of the fixing roll is set up at 180° C.
Illuminance of light irradiating device: 130,000 lux

A chart having a gradation image part with respect to each of Y, M, C, R, G, B and K colors is printed under the foregoing condition. Incidentally, the color image information is applied to the toner by a combination as shown in the following Table 1 (the generation of color development in LED marked with “*” means that the toner is color developed in a desired color). Furthermore, since the color development density is controlled by light emission intensity or light emission time, time-width modulation in which the time of one dot is divided into eight parts is employed.

TABLE 1

| Color | | | | | | | | | |
|---|---|---|---|---|---|---|---|---|---|
| developed | | Y | M | C | R | G | B | K | W |
| color | | color | color | color | color | color | color | color | color |
| Wave- | 405 | | * | * | | | * | | * |
| length | nm | | | | | | | | |
| of LED | 532 | * | | * | | * | | | * |
| | nm | | | | | | | | |
| | 657 | * | * | | * | | | | * |
| | nm | | | | | | | | |

### (Image Evaluation)

The print samples as obtained under the foregoing condition are evaluated as follows.

### —Color Development Density—

The image density of the solid image portion with respect to each of the Y, M and C colors is examined by using a densitometer X-Rite 938 (manufactured by X-Rite, Incorporated). As a result, sufficient color development is confirmed in all of the colors such that the image density is 1.5 or more.

### —Color Reproducibility—

The color reproducibility with respect to each of the R, G, B, Y, M and C colors is examined by a gradation chart at 5% steps of from 5% to 100%. As a result, color balance is satisfactory in all of the colors so that good color reproducibility is revealed.

### —Highlight Image Part Reproducibility—

The reproducibility of a highlight image part is examined by a 15% halftone image against the entire surface of a print. As a result, it is confirmed that the print is skip-free in the highlight part and satisfactory.

### Example 2

The image formation is carried out in the same manner as in the image formation of Example 1, except for changing the linear velocity of the image carrier 10 to 300 mm/sec, and the image is evaluated in the same manner as in Example 1. Furthermore, the fixing device and the light irradiating device are removed, thereby outputting an unfixed image under the same condition. After allowing it to stand in a dark place for 10 minutes, fixation and light irradiation are carried out at the same velocity and temperature to undergo the image formation.

As a result, there is obtained a print which is by no means inferior with respect to the color development density, color reproducibility and highlight image part reproducibility to the print in Example 1 irrespective of the presence or absence of standing.

### Example 3

The image formation is carried out in the same manner as in the image formation of Example 1, except for using the developing agent 2 in place of the developing agent 1, and the image is evaluated in the same manner as in Example 1.

As a result, in at least the initial image, a color development density which is equal to the density in Example 1 is obtained. In addition, with respect to the color reproducibility and highlight part reproducibility, better evaluation results than those in Example 1 are brought in a visual inspection level.

### Example 4

The image formation is carried out in the same manner as in the image formation of Example 1, except for using the developing agent 3 in place of the developinge agent 1 and changing applying the color information to a combination as shown in the following Table 2, and the image is evaluated in the same manner as in Example 1.

As a result, the color development density is 1.5 or more, and with respect to the color reproducibility and highlight image part reproducibility, results which are equal to those in Example 1 are brought in a visual inspection level. Thus, even in the case of using a light color development type toner, desired characteristics with respect to the color development density, color reproducibility and highlight image part reproducibility are obtained as in the case of the light non-color development type toner of Example 1.

TABLE 2

| Color | | | | | | | | | |
|---|---|---|---|---|---|---|---|---|---|
| developed | | Y | M | C | R | G | B | K | W |
| color | | color | color | color | color | color | color | color | color |
| Wave- | 405 | * | | | * | * | | * | |
| length | nm | | | | | | | | |
| of LED | 532 | | * | | * | | * | * | |
| | nm | | | | | | | | |
| | 657 | | | * | | * | * | * | |
| | nm | | | | | | | | |

### Comparative Example 1

### (Preparation of Toner)

First of all, a microcapsule-containing sheet as described in Japanese Patent No. 2979158 is prepared. Concretely, polyurethane is used as a wall material of a microcapsule, and a phospholipid bimolecular membrane having azobenzene as a photoisomerizing substance associated therewith is embedded in fine pores of this wall material. A leuco dye is contained inside this microcapsule, which is then dispersed in methyl cellulose containing α-naphthol as a developer to form a sheet.

This sheet is finely cut and further pulverized to prepare a particle having an average particle size of about 20 μm. This particle is subjected to a treatment with an external additive in the same manner as described previously to prepare a toner, which is further mixed with the foregoing carrier to prepare a developing agent 4.

Incidentally, all of these steps are carried out in a dark place.

### (Evaluation)

The image formation is carried out in the same manner as in the image formation of Example 4, except for using the developing agent 4 in place of the developing agnet 3, and the image is evaluated in the same manner as in Example 1. Furthermore, in the foregoing image formation, the image formation is carried out in the same manner, except for setting up the linear velocity of the photoreceptor at 300 m/sec, and after allowing it to stand as an unfixed image in a dark place for 10 minutes, fixation and light irradiation are carried out to undergo the image formation.

As a result, in the gathered sample, at the time when the linear velocity of the photoreceptor is 10 mm/sec, the image is faint in the density as a whole (image density: about 0.8 in average), and skipping in the highlight part is remarkable. Furthermore, at the time when the linear velocity of the photoreceptor is 300 mm/sec, although the image density and color tone are recovered (image density: about 1.0 in average), skipping in the highlight part is observed, and in particular, skipping is remarkable in halftones of not more than 20%. In addition, in the print sample after standing in a dark place for 10 minutes, color development does not substantially occur so that discrimination as images is impossible.

In the light of the above, in the image forming device (image forming method) using the toner in the Examples according to an aspect of the invention, even when the linear velocity of the image carrier 10 is largely changed, the image does not change and is stable. Furthermore, the reproducibility in the highlight image part is good, and an image with high image quality can be obtained. On the other hand, in the case of using the toner of the Comparative Example which is different in the color development mechanism from the toner of the invention, a stable image cannot be obtained even by employing the same device configuration.

### Example 5

In Examples 1 to 4, the image carrier 10 and the electrostatic latent image device 12 are changed to those described below, and the evaluation is made. As a result, the same results are obtained.
Image carrier: A dielectric drum resulting from successively forming a semi-conductive rubber layer having a thickness of 100 μm and a volume resistivity of 10⁶ Ωcm (material: carbon-dispersed NBR) and a dielectric layer having blended therein a calcium carbonate particle having a volume average particle size of 4 μm (acrylic resin layer having a surface roughness of 8 μm) on the periphery of an aluminum tube stock drum having a diameter of 30 mm (reflectance: 95%).
Electrostatic latent image forming device: A device of a multistylus electrode system of one-side control in which a number of stylus electrodes (discharge electrodes) and control electrodes thereof are arranged in a side of the image carrier surface such that the resolution is 600 dpi. Incidentally, with respect to the electrostatic latent image forming condition, −300 V is applied to the control electrodes, and +300 V is applied to the multistylus electrodes, thereby forming a plus latent image charge.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. An image forming apparatus including
an image carrier;
an electrostatic latent image forming unit that applying a charge to a surface of the image carrier to form a latent image;
a developing unit that develops the latent image by a toner to form a toner image;
a color information applying unit that applies the color information by light to the toner image;
a transfer unit that transfers the toner image onto a surface of a recording medium;
a fixing unit that fixes the toner image transferred onto the surface of the recording medium; and
a color forming unit that forms color of the toner image that is applied the color information,
the toner containing a first component and a second component that are present in an isolated state from each other and that can form the color upon reaction with each other, and a photocurable composition containing at least one of the first component and the second component, the photocurable composition keeping a cured or uncured state by being applied the color information by light, thereby being controlled a reaction for forming the color.

2. The image forming apparatus according to claim 1, wherein the image carrier is a dielectric; and the electrostatic latent image forming unit is an ion writing device.

3. The image forming apparatus according to claim 1, wherein the image carrier includes an elastic material having a volume resistivity of from about 10³ to about 10⁹ Ω·cm, and having an substantially uneven dielectric layer provided on a surface of the elastic material; and the electrostatic latent image forming unit is a discharge writing device.

4. The image forming apparatus according to claim 1, wherein the fixing unit also serves as a color forming unit.

5. The image forming apparatus according to claim 1, further comprising a light irradiating unit that irradiates light on a surface of the recording medium after fixing.

6. The image forming apparatus according to claim 1, wherein the toner contains a microcapsule dispersed in the photocurable composition, and the first component is contained within the microcapsule, and the second component is contained in the photocurable composition.

7. The image forming apparatus according to claim 6, wherein the second component and a polymerizable compound are contained in the photocurable composition.

8. The image forming apparatus according to claim 6, wherein the second component contains a polymerizable group.

9. An image forming method comprising:
applying a charge to a surface of an image carrier to form an electrostatic latent image;
developing the latent image by a toner to form a toner image;
applying the color information by light to the toner image;
transferring the toner image onto a surface of a recording medium;
fixing the toner image transferred onto the surface of the recording medium; and
forming color of the toner image that is applied the color information,
the toner containing a first component and a second component that are present in an isolated state from each other and that can form the color upon reaction with each other, and a photocurable composition containing at least one of the first component and the second component, the photocurable composition keeping a cured or uncured state by being applied the color information by light, thereby being controlled a reaction for forming the color.

10. A toner comprising a color former, and a photo curable developer monomer capable of being color-developed upon reaction with the color former.

11. The toner as claimed in claim 10, wherein
the color former and the photo curable developer monomer are separated from each other in the toner, and
a polymer formed through photopolymerization of the photo curable developer monomer is contained in the toner to prevent from being reacted with the color former.

12. The toner as claimed in claim 10, wherein
at least one of the color former and the photo curable developer monomer are contained in the microcapsule, and
a polymer formed through photopolymerization of the photo curable developer monomer dose not pass a wall of the microcapsules.

13. The toner as claimed in claim 10, wherein
the color former is selected from an electron donating colorless dye and a diazonium salt compound, and
the photo curable developer monomer is selected from an electron accepting compound and a coupler compound having a photopolymerizable group.

14. The toner as claimed in claim 13, wherein
the color former is an electron donating colorless dye, and
a content of the electron donating colorless dye at a color developing part in the toner is from about 0.01 to about 3 g/m².

15. The toner as claimed in claim 13, wherein
the color former is an electron donating colorless dye, and the photo curable developer monomer is a coupler compound having a photopolymerizable group, and
the coupler compound is contained in an amount of from about 0.5 to about 20 parts by mass per 1 part by mass of the electron donating colorless dye.

16. The toner as claimed in claim 13, wherein
the color former is a diazonium salt compound, and
a content of the diazonium salt compound at a color developing part in the toner is from about 0.01 to about 3 g/m².

17. The toner as claimed in claim 13, wherein
the color former is a diazonium salt compound, and the photo curable developer monomer is a coupler compound having a photopolymerizable group, and
the coupler compound is contained in an amount of from about 0.5 to about 20 parts by mass per 1 part by mass of the diazonium salt compound.

18. The toner as claimed in claim 10, wherein
the toner further comprises a spectral sensitizing dye and a borate compound, and a ratio of the spectral sensitizing dye to the borate compound in the toner is in a range of from about 1/1 to about 1/50.

19. The toner as claimed in claim 10, wherein p1 the toner has GSDv of about 1.30 or less, GSDv/GSDp of about 0.97 or more, and SF1 of from about 110 to about 130.

20. A toner comprising a color former, a developer capable of forming color upon reaction with the color former, and a photo polymerizable monomer.

21. The toner as claimed in claim 20, wherein
the color former and the developer are separated from each other in the toner, and
the photo polymerizable monomer undergoes photopolymerization to form a polymer, whereby the color former and the developer are reacted to each other to form the color.

22. The toner as claimed in claim 20, wherein
at least one of the color former and the developer are contained in the microcapsule.

23. The toner as claimed in claim 21, wherein
the photo polymerizable monomer contains decoloration reaction group capable of inhibiting color forming reaction between the color former and the developer.

24. The toner as claimed in claim 20, wherein
the color former is a polymerizable compound having an ethylenically unsaturated bond, and
the developer is selected from a phenol derivative, an organic carboxylic acid derivative and a metal salt thereof, a sulfonic acid derivative, urea and thiourea derivatives, acid clay, bentonite, a novolak resin and a metal complex.

25. The toner as claimed in claim 20, wherein
the toner further comprises a heat polymerization inhibitor.

26. The toner as claimed in claim 20, wherein
the toner has GSDv of about 1.30 or less, GSDv/GSDp of about 0.97 or more, and SF1 of from about 110 to about 130.
